(19) United States
(12) Patent Application Publication
(10) Pub. No.: US 2025/0284948 A1
(43) Pub. Date: Sep. 11, 2025

(54) THERMODYNAMIC COMPUTING SYSTEM CONFIGURED TO IMPLEMENT LAYER NORMALIZATION ARCHITECTURE

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 19/068,902

(22) Filed: Mar. 3, 2025

Related U.S. Application Data
(60) Provisional application No. 63/562,565, filed on Mar. 7, 2024.

(51) Int. Cl. G06N 3/065; G06N 3/049

(52) U.S. Cl. CPC G06N 3/065; G06N 3/049

(57) ABSTRACT

Systems, methods and computer readable media relating to neuro-thermodynamic computers configured to implement a layer normalization gadget, wherein the layer normalization gadget is configured to perform layer normalization operations. Thermodynamic data may be used as input to one or more thermodynamic chips comprising oscillators, wherein thermodynamic evolution according to one or more energy potentials governing the oscillators enable results of layer normalization to be obtained by respective ones of the oscillators. Furthermore, the results may be encoded as thermodynamic data in position degree of freedoms of respective oscillators.

### RELATED APPLICATION

This application claims benefit of priority to U.S. Provisional Application Ser. No. 63/562,565, entitled “Transformer-Based Architectures Using Thermodynamic Computing,” filed Mar. 7, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 illustrates an analog layer normalization gadget implemented on one or more thermodynamic chips comprising oscillators, according to some embodiments.

FIG. 2A illustrates the analog layer normalization gadget of FIG. 1, wherein respective ones of the oscillators undergo a first and second thermodynamic evolution, based on one or more potentials of the layer normalization gadget, to obtain a mean value of input oscillator values, according to some embodiments.

FIG. 2B illustrates the analog layer normalization gadget of FIG. 2A, wherein respective ones of the oscillators undergo a third thermodynamic evolution, based on one or more potentials of the layer normalization gadget, to obtain a variance value of input oscillators, according to some embodiments.

FIG. 2C illustrates the analog layer normalization gadget of FIG. 2B, wherein respective ones of the oscillators undergo a fourth thermodynamic evolution, based on one or more potentials of the layer normalization gadget, to obtain a reciprocal of the variance value of the input oscillators, according to some embodiments.

FIG. 2D illustrates the analog layer normalization gadget of FIG. 2C, wherein respective ones of the oscillators undergo a fifth thermodynamic evolution, based on one or more potentials of the layer normalization gadget, to obtain results of a layer normalization layer of a transformer neural network on output oscillators, according to some embodiments.

FIG. 3 illustrates an encoder block of a transformer neural network that is implemented on one or more thermodynamic chips comprising oscillators, according to some embodiments.

FIG. 4A illustrates an encoder block of a transformer neural network with a multi-head attention layer, wherein the encoder block is implemented on one or more thermodynamic chips comprising oscillators, according to some embodiments.

FIG. 4B illustrates a decoder block of a transformer neural network with a multi-head attention layer, wherein the decoder block is implemented on one or more thermodynamic chips comprising oscillators, according to some embodiments.

FIG. 5 illustrates an encoder block architecture of a transformer neural network implemented using one or more thermodynamic chips comprising oscillators, wherein multiple head attention layers, two add and norm layers and a feed forward layer are utilized, according to some embodiments.

FIG. 6 illustrates a plot of an example potential used to thermodynamically divide by a variance of input values, according to some embodiments.

FIG. 7A illustrates additional details of a relay gadget implemented using a thermodynamic chip, wherein the relay gadget is configured to relay thermodynamic information between a first energy-based model (EBM) and a second energy-based model

(EBM), such as an analog layer normalization gadget, according to some embodiments.

FIG. 7B is high-level diagram similar to FIG. 7A, wherein the relay gadget does not include a bias oscillator, according to some embodiments.

FIG. 8 is a high-level flowchart illustrating a process of relaying thermodynamic information between an output oscillator, such as of a first energy-based model (EBM), and an input oscillator, such as of an analog layer normalization gadget, according to some embodiments.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

FIG. 10 is a high-level diagram illustrating a spatial analogue relay gadget, wherein respective ones of relay oscillators of a group of relay oscillators are configured to store respective sample values of an output oscillator, according to some embodiments.

FIG. 11 is a high-level diagram illustrating a temporal analogue relay gadget, wherein a group of relay oscillators comprises a single relay oscillator, according to some embodiments.

FIG. 12 is a high-level diagram illustrating a series analogue relay gadget, wherein a group of relay oscillators comprises a plurality of relay oscillators arranged in series, according to some embodiments.

FIG. 13A illustrates example couplings between visible neurons of an energy-based model (EBM), according to some embodiments.

FIG. 13B illustrates example couplings between visible neurons and non-visible neurons (e.g., hidden neurons) of an energy-based model (EBM), according to some embodiments.

FIG. 14 is high-level diagram illustrating a process of determining weights and biases to be used in an energy-based model (EBM), wherein the weights and biases are determined using measurement values for synapse oscillators, according to some embodiments.

FIG. 15 is high-level diagram illustrating a process of determining weights and biases to be used in an energy-based model (EBM), wherein the weights and biases are computed using a classical computing device, according to some embodiments.

FIG. 16 is high-level diagram illustrating an example neuro-thermodynamic computer comprising a thermodynamic chip (e.g., that implements one or more energy-based models (EBMs), an analog layer normalization gadget, and a relay gadget) included in a dilution refrigerator and coupled to a classical computing device in an environment external to the dilution refrigerator, according to some embodiments.

FIG. 17 is high-level diagram illustrating an example neuro-thermodynamic computer comprising a thermodynamic chip (e.g., that implements one or more energy-based models (EBMs), an analog layer normalization gadget, and a relay gadget) included in a dilution refrigerator and coupled to a classical computing device that is also included in the dilution refrigerator, according to some embodiments.

FIG. 18 is high-level diagram illustrating an example neuro-thermodynamic computer comprising one or more thermodynamic chips (e.g., that implement one or more energy-based models (EBMs), an analog layer normalization gadget, and a relay gadget) coupled to a classical computing device in an environment other than a dilution refrigerator, according to some embodiments.

FIG. 19 is a high-level diagram illustrating oscillators included in a substrate of a thermodynamic chip and a mapping of the oscillators to logical neurons or synapses of the thermodynamic chip, according to some embodiments.

FIG. 20 is an additional high-level diagram illustrating oscillators included in a substrate of a thermodynamic chip mapped to logical neurons, weights, and biases (e.g., synapses) of a neuro-thermodynamic computing system, according to some embodiments.

FIG. 21 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems and an apparatus for performing computer operations using a thermodynamic chip and more specifically to an analog implementation of layer normalization. Such a thermodynamic, analog implementation of layer normalization may be referred to as a layer normalization gadget such as described herein. For example, the layer normalization gadget may be implemented using oscillators on one or more thermodynamic chips. Input oscillators may evolve to obtain input thermodynamic information, wherein the thermodynamic information (e.g., position, momentum, or force degrees of freedom associated with the oscillators) may encode vector component values of an input vector (e.g., input values). The oscillators of the one or more thermodynamic chip may thermodynamically evolve according to one or more potentials, wherein output oscillators encode a result of the layer normalization function. For example, a result value of the result of the layer normalization gadget may be a corresponding input value that is shifted by a mean value of the input values and scaled (e.g., divided) by a standard deviation of the input values. Other normalization conventions may be used. For example, the scaling factor may be related to another property of the input values such as the spread of input values.

In some embodiments, layer normalization may be used in a variety of applications. For example, layer normalization may be used in natural language processing, image recognition, object detection, image segmentation, computer vision, text classification, machine translation and speech recognition. Thermodynamic processing may enable faster processing times than classical hardware. For example, superconducting elements may quickly reach thermodynamic equilibrium.

In some embodiments, a set of engineered potentials may be used to enable output oscillators to obtain the result of the layer normalization. For example, a first potential of the set of engineered potentials may cause input oscillators, each input oscillator coupled to another oscillator, to thermodynamically evolve according to the first potential. Such a first thermodynamic evolution may enable the mean value oscillator to evolve to obtain a mean value of the input values, wherein the input values are encoded as thermodynamic data of respective input oscillators, and the mean value is encoded as thermodynamic data of the other oscillator (which may be referred to as a mean oscillator).

In some embodiments, the mean oscillator may uncouple from the input oscillators and a product of mass and frequency squared of the mean oscillator may increase such that the product is greater than a corresponding product for the input oscillators. Doing so may prepare the mean oscillator to shift input values encoded on the input oscillators by the mean value encoded on the mean oscillator. Thus, a second potential may be used to thermodynamically evolve oscillators of the one or more thermodynamic chips. The second potential may govern a second thermodynamic evolution, wherein the input oscillators are each coupled to the mean oscillator and the input values encoded on the input oscillators are shifted by the mean value. Thus, the second thermodynamic evolution according to the second potential enables the input values to be shifted by the mean value.

In some embodiments, a variance value of the input values may be thermodynamically obtained. For example, the input oscillators with input values that may or may not have been shifted by the mean value may couple to another oscillator (referred to as a variance oscillator), wherein a third thermodynamic evolution is performed. The third thermodynamic evolution, governed by a third potential, may enable the variance oscillator to evolve to obtain a variance value of the input values, wherein the variance value may be encoded as thermodynamic data on the variance oscillator. For the third thermodynamic evolution, a product of mass and frequency squared of the variance oscillator may be less than the corresponding product for the input oscillators.

In some embodiments, a reciprocal of the variance value may be thermodynamically obtained. For example, the variance oscillator with the variance value encoded thereon may be coupled with another oscillator (referred to as a variance reciprocal oscillator), wherein a fourth thermodynamic evolution is performed. The fourth thermodynamic evolution, governed by a fourth potential, may enable the variance reciprocal oscillator to obtain the reciprocal (e.g., multiplicative inverse) of the variance value, wherein the reciprocal variance value may be encoded as thermodynamic data on the variance reciprocal oscillator. For the fourth thermodynamic evolution, a product of mass and frequency squared of the variance reciprocal oscillator may be less than the corresponding product for the variance oscillator.

In some embodiments, a result of the layer normalization operation may be obtained using a fifth thermodynamic evolution governed by a fifth potential. For example, for a given input oscillators, a corresponding output oscillator may be coupled to the given input oscillator and the variance reciprocal oscillator, wherein the fifth thermodynamic evolution governed by the fifth potential is performed. Such coupling and evolution may be performed for each output oscillator. The fifth thermodynamic evolution may enable the output oscillators to evolve to obtain the result of the layer normalization operation. For example, a result value, encoded on a given output oscillator, of the result of the layer normalization gadget may be a corresponding input value that is shifted by a mean value of the input values and scaled (e.g., divided) by a standard deviation of the input values.

It should be noted that the mean oscillator, variance oscillator, and variance reciprocal oscillator may perform other tasks, wherein the oscillator is not governed to only perform the operations discussed herein especially regarding the name of the oscillator. More generally, the three oscillators described may be a type of oscillator referred to as a relay oscillator. Relay oscillators may have an adjustable mass and an adjustable frequency and are described in more detail herein.

Multiple types of computations, (e.g., such as layer normalization also referred to as “layer norm”) can be greatly accelerated when implemented on a thermodynamic processor, where the individual components of such models are oscillators implemented on superconducting circuit elements. However, in many applications, the desired operations need to be performed on circuits with multiple components (with each component performing a particular computation), which can add significant constraints on the selection of parameters for each of the oscillator of the thermodynamic chip. For example, if frequency or mass differentials (or combinations of both) between oscillators are used to cause thermodynamic information flow to move analog information between components in a desired manner, there are a limited number of easily achievable frequency and mass combinations of oscillators. Thus, the complexity of such systems quickly becomes self-limiting due to the inability to achieve thermodynamic information flow when primarily relying on mass and/or frequency differentials between oscillators to guide information flow. For example, in order to achieve thermodynamic information flow, it may be necessary that a value of mass times frequency squared of a sending oscillator is much greater than a corresponding value of mass times frequency squared of a receiving oscillator. As such, having the ability to modularize large circuits, with each modular component responsible for a particular task, such as performing layer normalization operations, is needed for implementing such models using thermodynamic processors. In such a modularized approach, mass and/or frequency differentials can be used within a given model, but a relay gadget can be used to relay information between modules, without a need to consider oscillator parameters of a given module when selecting oscillator parameters of another module. This modularization greatly simplifies the selection of oscillator parameters when designing a layer normalization gadget.

Broadly speaking, classes of algorithms (e.g., layer normalization) that may benefit from implementation using a thermodynamic chip include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as summing measured values and performing other non-compute intensive operations in order to implement a learning algorithm.

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons are used to perform computations. In some embodiments, temperatures less than 15 Kelvin may be used. Though other temperatures ranges are also contemplated. For example, some suitable types of oscillators may operate around room temperature. Neuro-thermodynamic computing, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency as well as masses, may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform learning tasks and operations.

In some embodiments, the output expectation value of one energy based model (EBM) block serves as the input to the next. For example, a layer normalization gadget may be an EBM providing output to a next EBM or the layer normalization gadget may be an EBM that receives input from a previous EBM or both. Furthermore, in some embodiments, such methods may be used to implement a transformer architecture within a mean-field NN framework. For example, EBM potential energy functions may be engineered as well as the neuron couplings for each component of the transformer architecture, ensuring that the output expectation values align with those produced by a transformer block implemented on a classical post-processing device.

Relay oscillators and relay gadgets communicate thermodynamic information (e.g., data) in an analog manner. This can be contrasted with other approaches to communicate information that involve reading out thermodynamic information, such as using a classical computing device, and then relaying the information in classical form. For example, the ability to relay thermodynamic information directly between components in a neuro-thermodynamic computer (e.g., between a layer normalization gadget and another energy based model (EBM)) avoids issues associated with readout to a classical computing device, such as read-out error, loss of information, and/or delays associated with performing readout. Moreover, if the information is to be used by another component of a neuro-thermodynamic computing device, relay of the information in a thermodynamic state avoids other delays such as would be incurred if required to initialize a receiving component to have an initial state corresponding to a state of the thermodynamic information that was read out from another component, wherein the relayed information is not already in a thermodynamic state. In some embodiments, such relay techniques as described herein may be used to relay thermodynamic information between energy-based models (EBMs). Such energy-based models (EBMs) may include trained models that evolve according to Langevin dynamics, and which may be used to generate inferences, such as machine learning (ML) inferences. For example, an ML model used to generate an ML inference may be physically implemented as a trained energy-based model (EBM). For example, an analog layer normalization gadget as described herein may be one such EBM, configured with an engineered potential that implements the layer normalization function.

As described herein, a relay gadget provides a solution to controlling thermal information flow without having to rely on various mass and frequency combinations between components to drive the thermodynamic information flow. For example, a relay gadget includes a relay oscillator that has a controllably adjustable mass and/or frequency that can be used to couple to oscillators belonging to other modules. This allows controlled thermodynamic information flow without having to worry about relative mass and/or frequency sizing between oscillators of the components (e.g., such as oscillators of an input EBM and oscillators of a destination EBM). For example, using a relay oscillator reduces the required constraints on the selection of parameters for oscillators belonging to different modules. The relay oscillator can also be used to obtain samples from various degrees of freedom of an oscillator. Such samples can be used to do Gibbs sampling.

### Layer Normalization

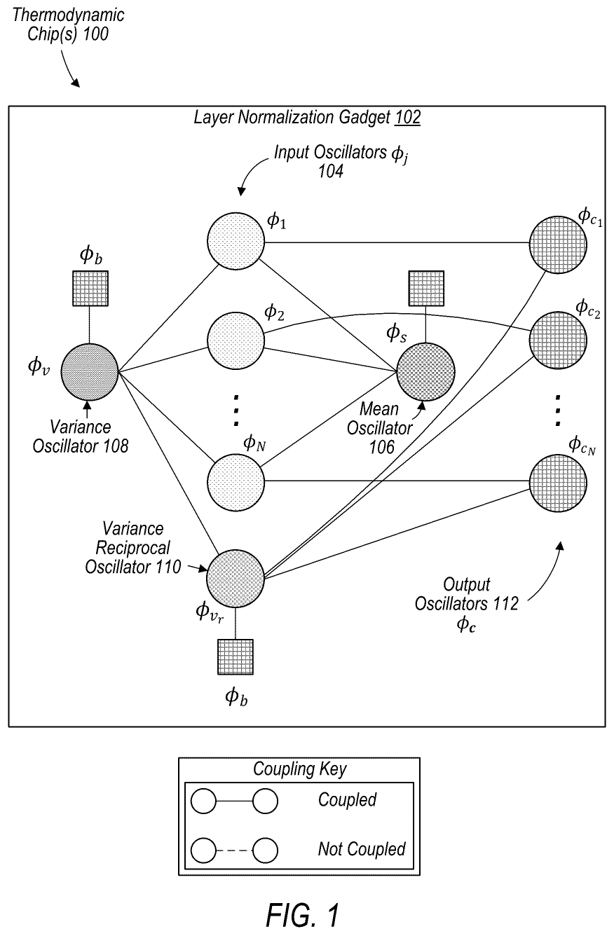

FIG. 1 illustrates an analog layer normalization gadget implemented on one or more thermodynamic chips comprising oscillators, according to some embodiments.

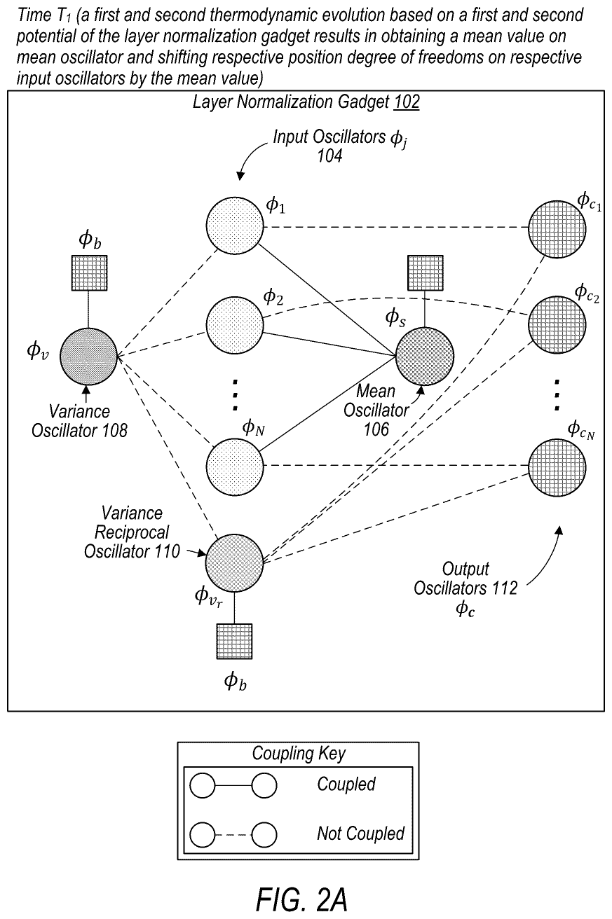

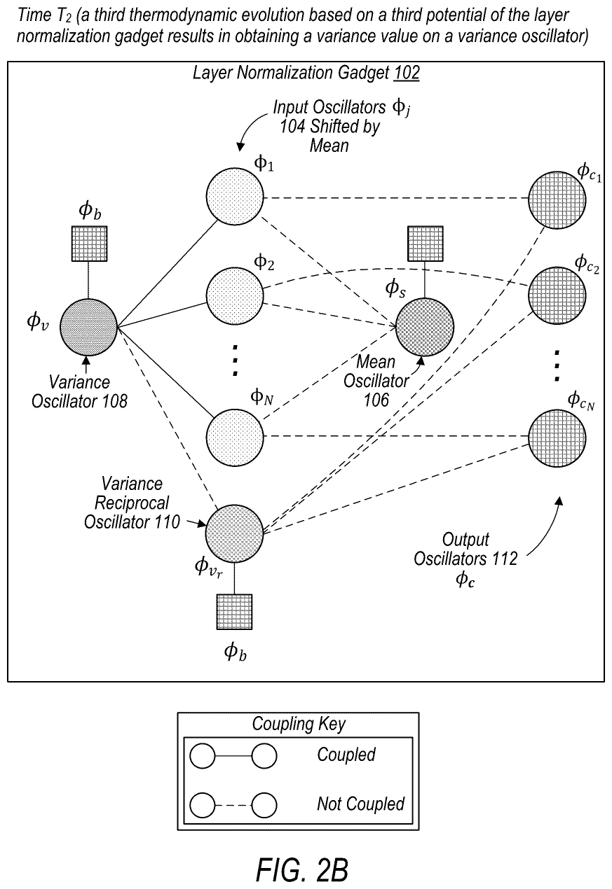

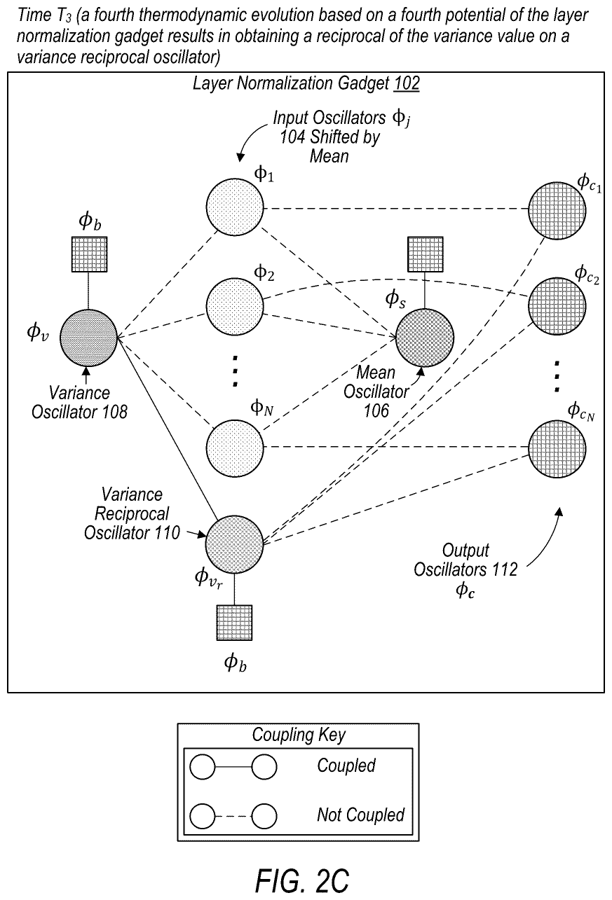

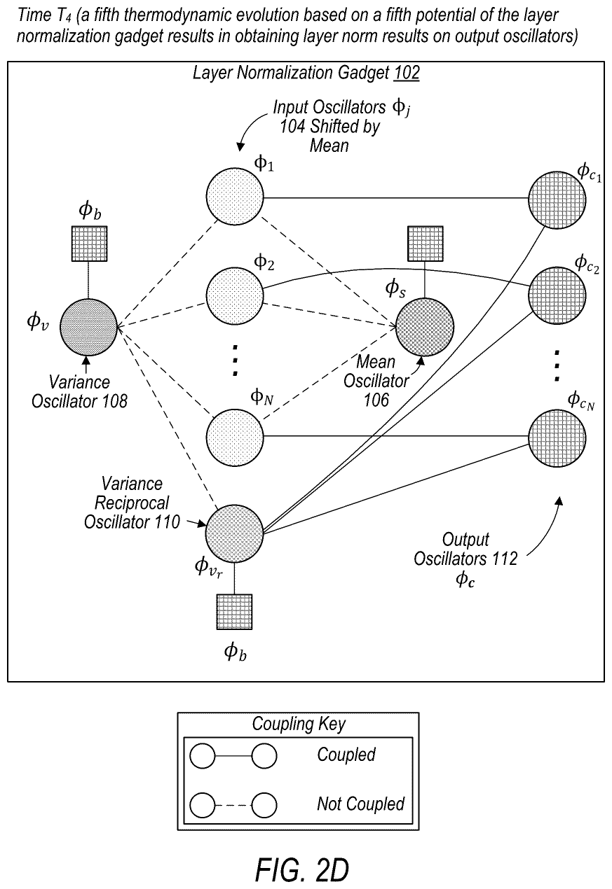

In some embodiments, layer normalization can be implemented on a thermodynamic processor (see eq. 21). An example architecture used to implement the layer norm gadget is shown in FIG. 1-2D. Such a gadget may be implemented in several parts as described below.

In some embodiments, a layer normalization gadget 102 may perform layer normalization. For example, layer normalization gadget 102 may have input oscillators 104 that obtain thermodynamic data to be provided to the gadget. Mean oscillator 106 with position degree of freedom ϕₛ is used to compute the mean of the input oscillators 104, and to shift the average at equilibrium of the j'th position by [symbol] ϕⱼ [symbol] → [symbol] ϕⱼ [symbol] −μ where

$$μ = \frac{1}{N} {\sum }_{j = 1}^{N} 〈 {ϕ}_{j} 〉 .$$

The variance oscillator 108 with position degree of freedom ϕᵥ is used to compute the variance, σ², given in eq. 23. Variance reciprocal oscillator 110 with position degree of freedom ϕᵥ_{ᵣ} may be coupled to variance oscillator 108 ϕᵥ in such a way that it reaches equilibrium at a value given by

$$\frac{1}{\sqrt{{σ}^{2} + ϵ}} .$$

Output oscillators 112 may be used which have a three-body coupling between the original input oscillators 104 and variance reciprocal oscillator 110 ϕᵥ_{ᵣ}. Note that the oscillators ϕₛ, ϕᵥ and ϕᵥ_{ᵣ}, as well as the input oscillators 104, are all used as EOs as part of the layer norm gadget protocol. As such, bias oscillators (illustrated as squares) may be optional, depending on the particular EO protocol being used.
Computing the Mean with Multiple EOs

FIG. 2A illustrates the analog layer normalization gadget of FIG. 1, wherein respective ones of the oscillators undergo a first and second thermodynamic evolution, based on one or more potentials of the layer normalization gadget, to obtain a mean value of input oscillator values, according to some embodiments.

In some embodiments the mean value of the input neurons 104 may be stored to the layer norm gadget 102. For example, an oscillator ϕₛ (e.g., mean oscillator 106) may be introduced that may be used to store a mean thermodynamic data of thermodynamic data of input oscillators 104. The mean oscillator 106 ϕₛ may then be used to shift the expectation value of the input neurons (e.g., input oscillators 104) by the mean.

Let {ϕ₁, . . . , ϕ_{N}} be the set of output oscillators from some previous gadget, wherein such oscillators may serve as input oscillators 104 for layer normalization gadget 102. It may be assume that the oscillator ϕⱼ∈{ϕ₁, . . . , ϕ_{N}} has an expectation value given by [symbol] ϕⱼ [symbol] =xⱼ, with mass m and frequency ω. The first potential describing the coupling between the mean oscillator 106 ϕₛ and the input oscillators 104 ϕⱼ∈{ϕ₁, . . . , ϕ_{N}} may be written as

$${V}_{1}^{( ln )} = \frac{1}{2} {m}_{s} {ω}_{s}^{2} {ϕ}_{s}^{2} + {λ}_{1} ( t ) {\sum }_{j = 1}^{N} {( {ϕ}_{s} - \frac{1}{N} {ϕ}_{j} )}^{2} , \qquad ( eq . 1 )$$

where in eq. 1 the ϕⱼ input oscillators 104 may be treated as static at the expectation value xⱼ since it may be assumed that mₛωₛ²<<mω². In what follows, ϕₛ may be treated as an EO, where its product mₛωₛ² will be increased after it is decoupled from all the ϕⱼ oscillators. In this case, the following may be written

$$\begin{matrix}〈 {ϕ}_{s} 〉 \approx \frac{\int d {ϕ}_{s} {ϕ}_{s} {e}^{- β {V}_{1}^{( ln )}}}{\int d {ϕ}_{s} {e}^{- β {V}_{1}^{( ln )}}} \\ \approx \frac{2 {λ}_{1} \frac{1}{N} {\sum }_{j = 1}^{N} {x}_{j}}{2 {λ}_{1} + {m}_{s} {ω}_{s}^{2}} .\end{matrix} \qquad ( eq . 2 )$$

Thus, by setting mₛωₛ²/(2λ₁)<<1, a desired result (e.g., a mean value of input oscillator thermodynamic data) may be obtained.

In some embodiments, after decoupling ϕₛ mean oscillator 106 from the set of {ϕ₁, . . . , ϕ_{N}} input oscillators 104 by turning λ₁(t) off, a product of mass and frequency squared of the mean oscillator 106, mₛωₛ², may simultaneously be increased such that ϕₛ mean oscillator 106 effectively becomes static at its expectation value, wherein the expectation value may be represented by

$$μ = \frac{1}{N} {\sum }_{j = 1}^{N} {x}_{j} .$$

Further, mₛωₛ² may be tuned such that mₛωₛ²>>mω². This allows the ϕₛ mean oscillator 106 to perturb the {ϕ₁, . . . , ϕ_{N}} input oscillators 104 while treating ϕₛ mean oscillator 106 as static. Once mₛωₛ² has been tuned, the coupling between ϕₛ mean oscillator 106 and the {ϕ₁, . . . , ϕ_{N}} input oscillators 104 may be turned back on using a second potential given by

$${V}_{2}^{( ln )} = \frac{1}{2} m {{ω}^{2} ( {ϕ}_{j} - {x}_{j} )}^{2} + {λ}_{2} ( t ) {( {c}_{1} {ϕ}_{j} - {c}_{2} {ϕ}_{S} )}^{2} , \qquad ( eq . 3 )$$

for some constants c₁ and c₂. Without loss of generality, the term

$$\frac{1}{2} m {{ω}^{2} ( {ϕ}_{j} - {x}_{j} )}^{2}$$

is included instead of considering the previous EO dynamics of ϕⱼ which leads it to remain static at xⱼ. The expected value for the [symbol] ϕⱼ [symbol] oscillator is now

$$\begin{matrix}( {ϕ}_{j} 〉 \approx \frac{\int d {ϕ}_{j} {ϕ}_{j} {e}^{- β {V}_{2}^{( l n )}}}{\int d {ϕ}_{j} {e}^{- β {V}_{2}^{( ln )}}} \\ \approx \frac{α}{1 + α} {x}_{j} + \frac{{c}_{2}}{{c}_{1} ( 1 + α )} μ ,\end{matrix} \qquad ( eq . 4 )$$

where it may be engineered that

$$α = \frac{{m}_{j} {ω}_{j}^{2}}{2 {λ}_{2} {c}_{1}^{2}} , \qquad ( eq . 5 )$$

with λ₂ being the max value of λ₂(t). ϕₛ may be treated as static at its equilibrium values given in eq. 2. Now if α>>1, eq. 4 simplifies to

$$\begin{matrix}( {ϕ}_{j} 〉 \approx {x}_{j} + \frac{{c}_{2}}{{c}_{1} α} μ \\ = {x}_{j} - μ ,\end{matrix} \qquad ( eq . 6 )$$

where in going from the first to the second line in eq. 6, the condition c₂=−c₁α may be set.

Finally, the {ϕ₁, . . . , ϕ_{N}} input oscillators 104 may be decoupled from ϕₛ mean oscillator 106 by setting λ₂(t) back to zero while simultaneously increasing the product of mω² such that the ϕⱼ oscillators become static at the equilibrium value given in eq. 6.

### Computing the Variance

FIG. 2B illustrates the analog layer normalization gadget of FIG. 2A, wherein respective ones of the oscillators undergo a third thermodynamic evolution, based on one or more potentials of the layer normalization gadget, to obtain a variance value of input oscillators, according to some embodiments.

The next step is to compute the variance

$${σ}^{2} = \frac{1}{N - 1} {\sum }_{j = 1}^{N} {( {x}_{j} - μ )}^{2} .$$

In doing so, a new variance oscillator 108 ϕᵥ may be introduced which will act as an EO (e.g., a relay oscillator). Prior to coupling variance oscillator 108 ϕᵥ to the {ϕ₁, . . . , ϕ_{N}} input oscillators 104 shifted by the mean, the condition mᵥωᵥ²<<mω² may be set. The third potential describing the coupling between variance oscillator 108 ϕᵥ and the {ϕ₁, . . . , ϕ_{N}} input oscillators 104 shifted by the mean may be given by

$${V}_{3}^{( ln )} = \frac{1}{2} {m}_{v} {ω}_{v}^{2} {ϕ}_{v}^{2} + \frac{1}{2} m {ω}^{2} {\sum }_{j = 1}^{N} {( {ϕ}_{j} - ( {x}_{j} - μ ) )}^{2} - {λ}_{3} ( t ) {ϕ}_{v} {\sum }_{j = 1}^{N} {ϕ}_{j}^{2} . \qquad ( eq . 7 )$$

Now before calculating [symbol] ϕᵥ [symbol] , note a subtlety in the estimator oscillator (EO) protocol due to the λ₃(t)ϕᵥΣⱼ₌₁^{N}ϕⱼ² term in eq. 7 which contains the quadratic term ϕⱼ². In some embodiments, the smaller the product mω², the more variance will be present in the state of the {ϕ₁, . . . , ϕ_{N}} input oscillators 104 around its equilibrium value. For example, the potential in eq. 65 may be used to compute [symbol] ϕⱼ² [symbol] which is given by

$$\begin{matrix}{ϕ}_{j}^{2} \approx \frac{\int d {ϕ}_{j} {ϕ}_{j}^{2} {e}^{− β {V}_{3}^{( ln )}}}{\int d {ϕ}_{i} {e}^{− β {V}_{3}^{( ln )}}} \\ = {( {x}_{j} + \frac{{λ}_{1}}{m {ω}^{2}} μ )}^{2} + \frac{1}{β m {ω}^{2}} \\ = {( {x}_{j} - μ )}^{2} + \frac{{k}_{B} T}{m {ω}^{2}} ,\end{matrix} \qquad ( eq . 8 )$$

where in going from the second to third line the condition λ₁=−mω² is set. Comparing with eq. 4, the addition of the term

$$\frac{1}{β m {ω}^{2}}$$

in eq. 8 represents the variance. Further, in the limit of large mω² and small temperature, the variance term can be made to be very small. In what follows, since the ϕⱼ oscillators are EOs and treated as static due to a large mω² term, the replacement ϕⱼ→(xⱼ−μ) may be utilized.

Given the above, it may be written that

$$\begin{matrix}〈 {ϕ}_{v} 〉 \approx \frac{\int d {ϕ}_{v} {ϕ}_{v} {e}^{- β {V}_{3}^{( ln )}}}{\int d {ϕ}_{v} {e}^{- β {V}_{3}^{( ln )}}} \\ = \frac{{λ}_{3}}{{m}_{v} {ω}_{v}^{2}} {\sum }_{j = 1}^{N} {( {x}_{j} - μ )}^{2} \\ = \frac{1}{N - 1} {\sum }_{j = 1}^{N} {( {x}_{j} - μ )}^{2} = {σ}^{2} ,\end{matrix} \qquad ( eq . 9 )$$

where the condition

$${λ}_{3} = \frac{{m}_{v} {ω}_{v}^{2}}{N - 1}$$

is set. Lastly, note that other coupling terms or potentials are also possible. For instance, the following third potential may be used

$${V}_{3}^{( ln )} = \frac{1}{2} {m}_{v} {ω}_{v}^{2} {ϕ}_{v}^{2} + \frac{1}{2} m {ω}^{2} {\sum }_{j = 1}^{N} {( {ϕ}_{j} - ( {x}_{j} - μ ) )}^{2} - {λ}_{3} ( t ) {( {ϕ}_{v} - c {\sum }_{j = 1}^{N} {ϕ}_{j}^{2} )}^{2} , \qquad ( eq . 10 )$$

for some constant c. Repeating the same calculation that lead to eq. 9, a desired result may be obtained with the condition that mᵥωᵥ²/(2λ₃)<<1 and c=1/(N−1).

After reaching thermal equilibrium, the coupling between ϕᵥ variance oscillator 108 and the {ϕ₁, . . . , ϕ_{N}} input oscillators 104 may be turned off, and mᵥωᵥ² of the variance oscillator 108 may be tuned to ensure that ϕᵥ variance oscillator 108 remains static at the equilibrium value given in eq. 9.

### Dividing by the Variance

FIG. 2C illustrates the analog layer normalization gadget of FIG. 2B, wherein respective ones of the oscillators undergo a fourth thermodynamic evolution, based on one or more potentials of the layer normalization gadget, to obtain a reciprocal of the variance value of the input oscillators, according to some embodiments.

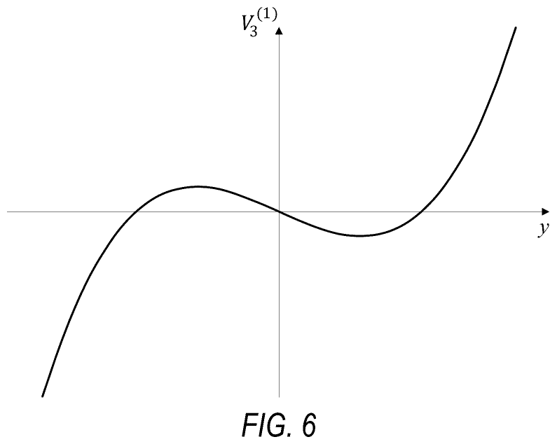

Consider a fourth potential of the form

$${V}_{4}^{( ln )} = {A}_{1} {ϕ}_{{v}_{r}}^{3} ( {ϕ}_{v} + ϵ ) - {A}_{2} {ϕ}_{{v}_{r}} , \qquad ( eq . 11 )$$

where ϕᵥ variance oscillator 108 is treated as a constant at its equilibrium value σ² since it is a EO. An example of the potential energy in eq. 11 is plotted in FIG. 6. € (in units of position) may be added which is a small positive constant. The oscillator ϕᵥ_{ᵣ} variance reciprocal oscillator 110 may be used to store the value 1/\sqrt{σ²}. A local minima of V₃⁽¹⁾ is given at

$${ϕ}_{{v}_{r}} = \pm \sqrt{\frac{{A}_{2}}{3 {A}_{1}}} \frac{1}{\sqrt{{σ}^{2} + ϵ}} . \qquad ( eq . 12 )$$

wherein the condition A₂=3A₁ may be set. As illustrated in FIG. 6, for large enough A₁ and ϕᵥ_{ᵣ} variance reciprocal oscillator 110 initialized at zero, the probability that ϕᵥ_{ᵣ} variance reciprocal oscillator 110 converges to the local minima may be close to 1. As such, it may be choose that A₁>>1 and ϕᵥ_{ᵣ} variance reciprocal oscillator 110 may be initialized to zero prior to coupling ϕᵥ_{ᵣ} variance reciprocal oscillator 110 to ϕᵥ variance oscillator 108. Since ϕᵥ variance oscillator 108 is an EO, it may be assumed that the condition mᵥ_{ᵣ}ωᵥ_{ᵣ}²<<mᵥωᵥ² is set and the variance oscillator 108 ϕᵥ may be treated as static at its equilibrium value. The integral in computing the expectation value of ϕᵥ_{ᵣ} variance reciprocal oscillator 110 may be written as

$$\begin{matrix}〈 {ϕ}_{{v}_{r}} 〉 \approx \frac{\int d {ϕ}_{{v}_{r}} {ϕ}_{{v}_{r}} {e}^{- β {V}_{4}^{( ln )} ( {ϕ}_{{v}_{r}} )}}{\int d {ϕ}_{{v}_{r}} {e}^{- β {V}_{4}^{( ln )} ( {ϕ}_{{v}_{r}} )}} \\ \approx \frac{1}{\sqrt{{σ}^{2}}} \frac{{e}^{- β {V}_{4}^{( ln )} ( \frac{1}{\sqrt{{σ}^{2} + ϵ}} )}}{{e}^{- β {V}_{4}^{( ln )} ( \frac{1}{\sqrt{{σ}^{2} + ϵ}} )}} \\ = \frac{1}{\sqrt{{σ}^{2} + ϵ}}\end{matrix} , \qquad ( eq . 13 )$$

since the probability of finding ϕᵥ_{ᵣ} variance reciprocal oscillator 110 away from the local minima is exponentially small.

After reaching its thermal equilibrium value, ϕᵥ_{ᵣ} variance reciprocal oscillator 110 may decoupled from ϕᵥ variance oscillator 108. The term mᵥ_{ᵣ}ωᵥ_{ᵣ}² may simultaneously be tuned using the EO formalism to ensure that the ϕᵥ_{ᵣ} variance reciprocal oscillator 110 can be treated as static as needed in the step below.

Note that from a hardware perspective, it may be more natural to consider the following fourth potential

$${V}_{4}^{( ln )} = {A}_{1} {ϕ}_{{v}_{r}}^{4} ( {ϕ}_{v} + ϵ ) - \frac{1}{2} {m}_{{v}_{r}} {ω}_{{v}_{r}}^{2} {ϕ}_{{v}_{r}}^{2} , \qquad ( eq . 14 )$$

due to the quadratic and quartic terms. Such a potential has a local minimum at 0, and global minima at

$${ϕ}_{{v}_{r}} = \pm \sqrt{\frac{\frac{1}{2} {m}_{{v}_{r}} {ω}_{{v}_{r}}^{2}}{2 {A}_{1} ( {σ}^{2} + ϵ )}} , \qquad ( eq . 15 )$$

where again ϕᵥ variance oscillator 108 may be treated as static at its equilibrium value σ². By setting

$$\frac{1}{2} {m}_{{v}_{r}} {ω}_{{v}_{r}}^{2} = 2 {A}_{1} , \qquad ( eq . 16 )$$

a desired result may be obtained if ϕᵥ_{ᵣ} variance reciprocal oscillator 110 is initialized at some large positive value, and A₁ is large (since in this case ϕᵥ_{ᵣ} variance reciprocal oscillator 110 will quickly reach equilibrium on the right-side of the double well potential). However, since ϕᵥ_{ᵣ} variance reciprocal oscillator 110 is an EO with

$$\frac{1}{2} {m}_{{v}_{r}} {ω}_{{v}_{r}}^{2} ≪ \frac{1}{2} {m}_{v} {ω}_{v}^{2} ,$$

a careful choice of parameters is required to ensure that the constraint in eq. 16 is satisfied with large A₁.

### Storing the Final Layer Norm Result

FIG. 2D illustrates the analog layer normalization gadget of FIG. 2C, wherein respective ones of the oscillators undergo a fifth thermodynamic evolution, based on one or more potentials of the layer normalization gadget, to obtain results of a layer normalization layer of a transformer neural network on output oscillators, according to some embodiments.

The final step involves coupling the variance reciprocal oscillators 110 ϕᵥ_{ᵣ} and input oscillators 104 {ϕ₁, . . . , ϕ_{N}} to final output oscillators 110 of the layer norm gadget 102 which may be labeled {ϕ_{c}_{₁}, . . . , ϕ_{c}_{_{N}}}. To do so, the fifth potential

$${V}_{thb} = \frac{1}{2} {m}_{c} {ω}_{c}^{2} {\sum }_{j = 1}^{N} {ϕ}_{{c}_{j}}^{2} + {λ}_{4} ( t ) {ϕ}_{{v}_{r}} {\sum }_{j = 1}^{N} {ϕ}_{j} {ϕ}_{{c}_{j}} , \qquad ( eq , 17 )$$

may be used where the oscillators ϕᵥ_{ᵣ} and {ϕ₁, . . . , ϕ_{N}} are treated as static. It may be assumed in some embodiments that the conditions m_{c}ω_{c}²<<mω² and m_{c}ω_{c}²<<mᵥ_{ᵣ}ωᵥ_{ᵣ}² are met. At equilibrium, the final output oscillators of the layer norm gadget may be written as

$$\begin{matrix}〈 {ϕ}_{{c}_{j}} 〉 \approx \frac{\int d {ϕ}_{{c}_{1}} … d {ϕ}_{{c}_{N}} {ϕ}_{{c}_{j}} {e}^{- β {V}_{thb}}}{\int d {ϕ}_{{c}_{1}} … d {ϕ}_{{c}_{N}} {e}^{- β {V}_{thb}}} \\ \approx - \frac{{λ}_{4} ( t )}{{m}_{c} {ω}_{c}^{2}} 〈 {ϕ}_{{v}_{r}} 〉 〈 {ϕ}_{j} 〉 \\ = - \frac{{λ}_{4} ( t )}{{m}_{c} {ω}_{c}^{2}} \frac{{x}_{j} - μ}{\sqrt{{σ}^{2} + ϵ}}\end{matrix} . \qquad ( eq . 18 )$$

By setting the max value of λ₄=−m_{c}ω_{c}², a desired result of the layer norm gadget on the output oscillators {ϕ_{c}_{₁}, . . . , ϕ_{c}_{_{N}}} may be obtained. Note that the following fifth potential may also be used

$${V}_{thb}^{( 2 )} = \frac{1}{2} {m}_{c} {ω}_{c}^{2} {\sum }_{j = 1}^{N} {ϕ}_{{c}_{j}}^{2} + {λ}_{4} ( t ) {( {ϕ}_{{v}_{r}} {\sum }_{j = 1}^{N} {ϕ}_{j} - {ϕ}_{{c}_{j}} )}^{2} . \qquad ( eq . 19 )$$

In this case, the final output oscillators of the layer norm gadget may be written as

$$\begin{matrix}〈 {ϕ}_{{c}_{j}} 〉 \approx \frac{2 {λ}_{4}}{2 {λ}_{4} + {m}_{c} {ω}_{c}^{2}} 〈 {ϕ}_{{v}_{r}} 〉 〈 {ϕ}_{j} 〉 \\ = \frac{2 {λ}_{4}}{2 {λ}_{4} + {m}_{c} {ω}_{c}^{2}} \frac{{x}_{j} - μ}{\sqrt{{σ}^{2} + ϵ}}\end{matrix} . \qquad ( eq . 20 )$$

Note that if 2λ₄>>m_{c}ω_{c}², a desired result may be obtained.

In some embodiments, the potentials considered in above may use time dependent pulses. Such pulses are used to turn on and off the desired couplings between the relevant oscillators (such that EO methods may be applied), and that the derived values for the coupling strengths represent the max values of said pulses while the relevant oscillators are coupled. An illustration of the entire layer norm gadget is shown in FIG. 1-2D.

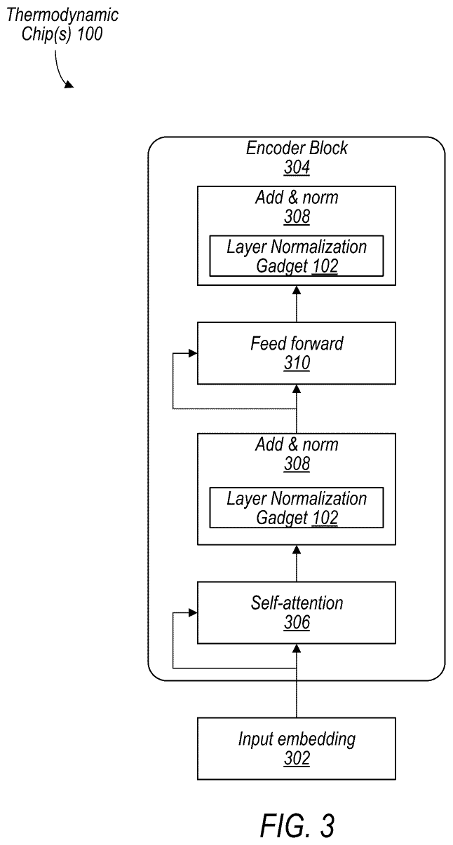

FIG. 3 illustrates an encoder block of a transformer neural network that is implemented on one or more thermodynamic chips comprising oscillators, according to some embodiments.

For example, an attention block, also referred to as an encoder block 304, may be implemented on one or more thermodynamic chip(s) 100. Encoder block 304 may begin with input embedding 302, which can be precomputed in software before clamping input neurons to the data. Next, the self-attention 306 layer is applied, followed by a skip connection that adds the input to the self-attention output. Layer normalization using layer normalization gadget 102 of add & norm 308 layer may then performed. The resulting output of add & norm 308 is passed through a feed forward 310 network, and another skip connection and a subsequent layer normalization step using layer normalization gadget 102 are applied (e.g., as part of add & norm 308). Each layer may be performed using couplings between oscillators of the thermodynamic chip(s) 100.

In some embodiments, a transformer block comprises four main operations: a self-attention 306 layer, a feed forward 310 neural network layer, layer normalization using layer normalization gadget 102, and skip connections (also known as add layers) (e.g., add & norm 308 layer). One goal of the transformer may be to learn relationships between tokens that represent the input data. These tokens are first converted into embeddings, which transform discrete, symbolic data (e.g., words, image, etc.) into continuous vectors that can be processed by the neural network.

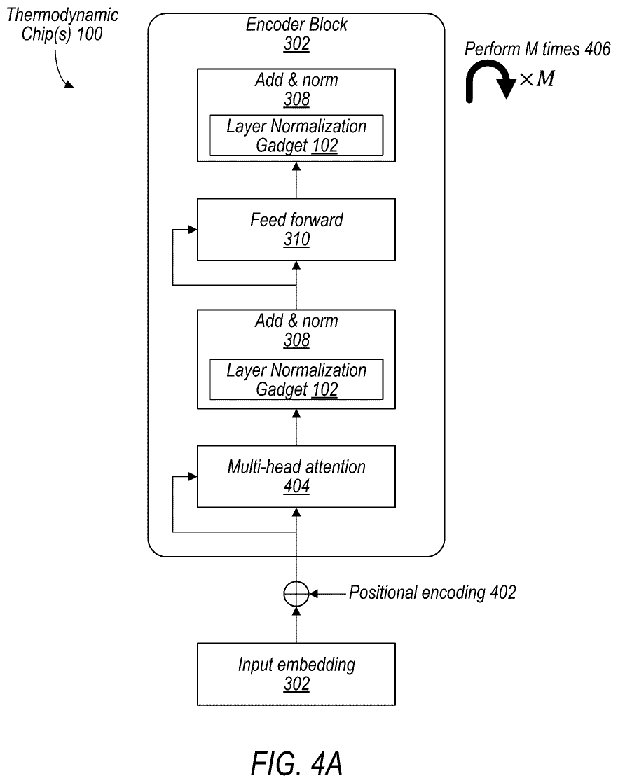

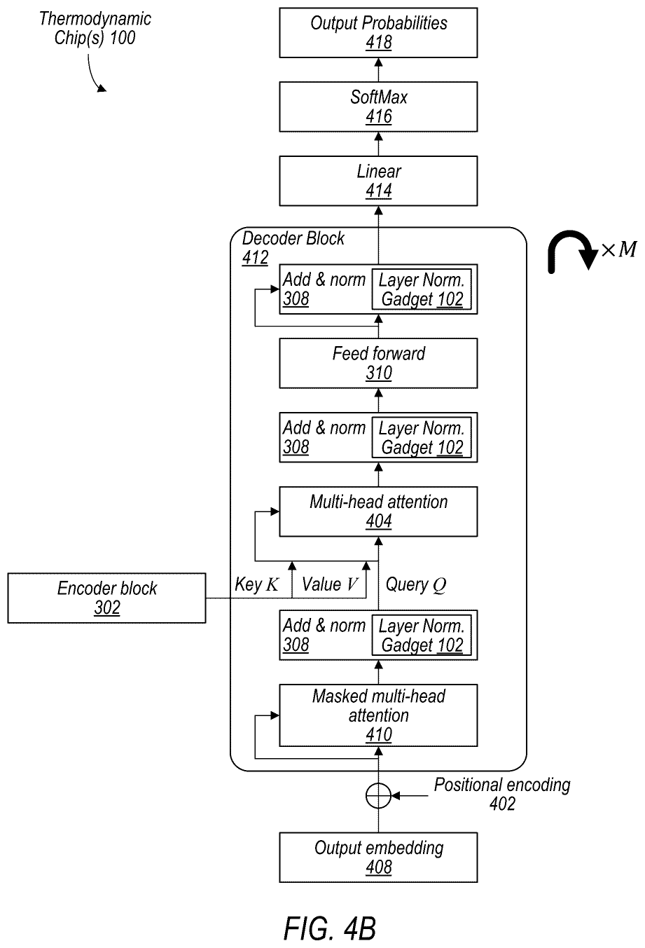

FIG. 4A illustrates an encoder block of a transformer neural network with a multi-head attention layer, wherein the encoder block is implemented on one or more thermodynamic chips comprising oscillators, according to some embodiments.

In some embodiments, an encoder block in a transformer architecture includes a multi-head attention 404 mechanism, followed by a skip connection and layer normalization using layer normalization gadget 102 (add & norm 308 layer). The output is then passed through a feed forward 310 network, followed by another skip connection and layer normalization using layer normalization gadget 102 (add & norm 308). The encoder block 302 may be repeated M times, with each repetition using an independent set of weights. Initially, raw input tokens are converted into vectors via an embedding layer and combined with fixed positional encoding 402 vectors (non-learnable parameters in this work). For subsequent repetitions, the output of the previous encoder block 302 serves as the input to the next.

FIG. 4B illustrates a decoder block of a transformer neural network with a multi-head attention layer, wherein the decoder block is implemented on one or more thermodynamic chips comprising oscillators, according to some embodiments.

In some embodiments, a decoder block 412 begins with a masked multi-head attention 410 layer during training to ensure it only attends to tokens that have already been seen. The query (Q) matrix for the second multi-head attention 404 layer is obtained from the output of the masked self-attention 410 layer, while the key (K) and value (V) matrices are derived from output of an encoder block 302. Similar to the encoder block 302, the decoder block 412 may be repeated M times, with each repetition using an independent set of weights. The final output of the decoder block is passed through a linear 414 layer and a SoftMax 416 function to compute output probabilities 418.

### Add and Norm

In some embodiments, an add and layer normalization may be performed. The add layer consists of adding the input embedding vectors to the outputs of a Self-Attention layer. Afterwords, a layer normalization step may be performed. See FIGS. 1-2D for a thermodynamic implementation of layer normalization. Consider an add and norm layer applied to a vector x of size N. The layer norm step performs the following operation

$${x}_{i} \to \frac{{x}_{i} - μ}{\sqrt{{σ}^{2} + ϵ}} , \qquad ( eq . 21 )$$

for all components (e.g., each component i) of the vector x. In eq. 21, ∈ is a small positive constant to avoid division by zero, and a mean and variance are respectively

$$μ = \frac{1}{N} {\sum }_{j = 1}^{N} {bx}_{j} , \qquad ( eq . 22 )$$

$$and$$

$${σ}^{2} = \frac{1}{N} {\sum }_{j = 1}^{N} {( {x}_{j} - μ )}^{2} . \qquad ( eq . 23 )$$

In layer normalization, each component of the input vector x is first centered by subtracting the mean and then scaled by dividing by the square root of the variance squared plus a small constant to prevent division by zero. This technique is used in deep learning to stabilize training by ensuring that activations within a layer remain within a manageable range, preventing excessively large gradient steps during backpropagation. As a result, the activations are normalized to have a small range centered around zero.

### Encoder Block

Example embodiments of encoder block 302, which includes a multi-head attention 404 mechanism, is illustrated in FIG. 4A Positional encoding 402 vectors are added to the input embedding vectors to incorporate information about the relative or absolute positions of tokens in the input sequence. In other embodiments, various approaches exist for constructing positional encodings, including learnable parameters.

In a transformer architecture, the encoder block 302 is typically repeated M times. The output of each encoder block serves as the input to the next, with each repetition using a new set of weights for the multi-head attention and feedforward layers.

### Decoder Block

Example embodiments of a decoder block 412 consists of two multi-head attention mechanisms and a feedforward layer. The first multi-head attention block employs masked self-attention during training (e.g., masked multi-head attention 410). Masking ensures that the model does not use information from future tokens that have not yet been seen. This is achieved by adding a masking matrix Mₐ, where the columns corresponding to seen tokens are set to zero, and all other columns are assigned −∞. The masked self-attention operation is given by

$$MaskedSelfAttn ( X ) = VSoftmax ( \frac{{K}^{T} Q}{\sqrt{D}} + {M}_{a} ) . \qquad ( eq . 24 )$$

The output of the first masked self-attention block is then used to compute the query (Q) matrix for the second multi-head attention block. The key (K) and value (V) matrices for the second attention block may be obtained from the output of the encoder block.

In some embodiments, similar to the encoder block, the decoder block is repeated M times. After the M-th iteration, the output of the feedforward layer is passed to a linear layer, which computes y=Wx+b where x is the input vector, and W and b are the weight and bias parameters respectively. Finally, the output of the linear layer is fed into a Softmax function to produce probabilities. An illustration of the decoder block is provided in FIG. 4B.

### Mean Field Backwards Propagation for Training the Transformer Network

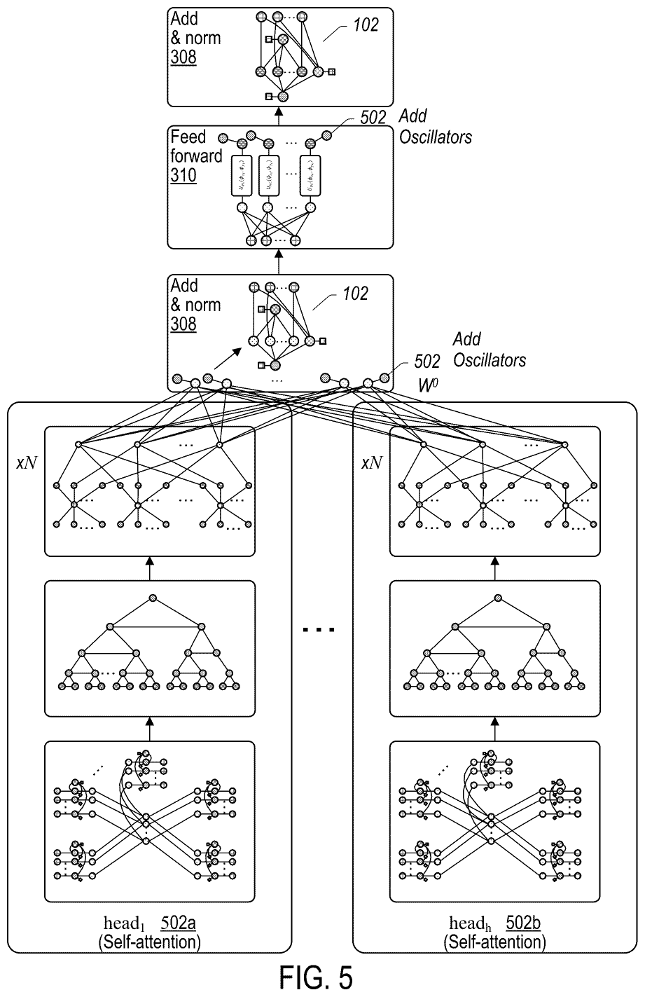

FIG. 5 illustrates an encoder block architecture of a transformer neural network implemented using one or more thermodynamic chips comprising oscillators, wherein multiple head attention layers, two add and norm layers and a feed forward layer are utilized, according to some embodiments.

For example, FIG. 5 illustrates an example of a full encoder block architecture, where each component is illustrated with its implementation on a thermodynamic processor. The bottom portion of the figure illustrates the multi-head attention (e.g., with head₁ 502a through headₕ 502b), with the Lone-Star gadget, the SoftMax gadget and the attention layer. The add oscillators 502 coupled to the outputs perform the add layer, and the layer norm block is shown in FIG. 1-2D. Finally, the feedforward network shown in FIG. 4 may be implemented, which consists of a matrix multiplication followed by some activation function which may be labeled with the potential U_{NL}. The figure concludes with another add and norm layer.

In some embodiments, a full encoder block of a transformers architecture, implemented on a thermodynamic processor, is shown in FIG. 5. The transformer architecture can be trained using mean-field forwards and backwards propagation steps. For example, consider potential energy functions of EBM blocks which have learnable parameters. Further, for both EBMs with and without parameters in the transformer architecture presented above, expectation values are used for the output of a given block to be used as inputs to the next block.

FIG. 6 illustrates a plot of an example potential used to thermodynamically divide by a variance of input values, according to some embodiments.

In some embodiments, a potential may have the form of a cubic function such as illustrated in FIG. 6. An example of such an oscillator is described below for FIG. 4C and written in eq. 11.

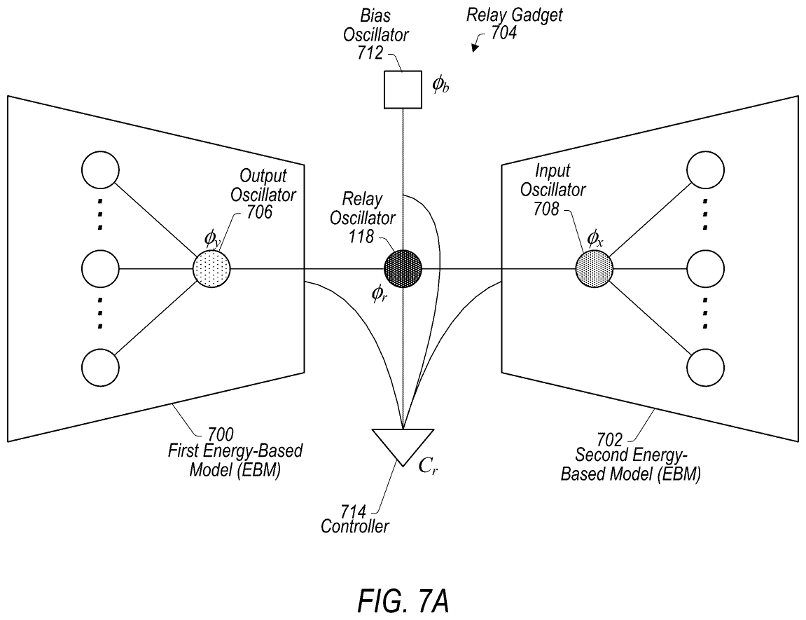

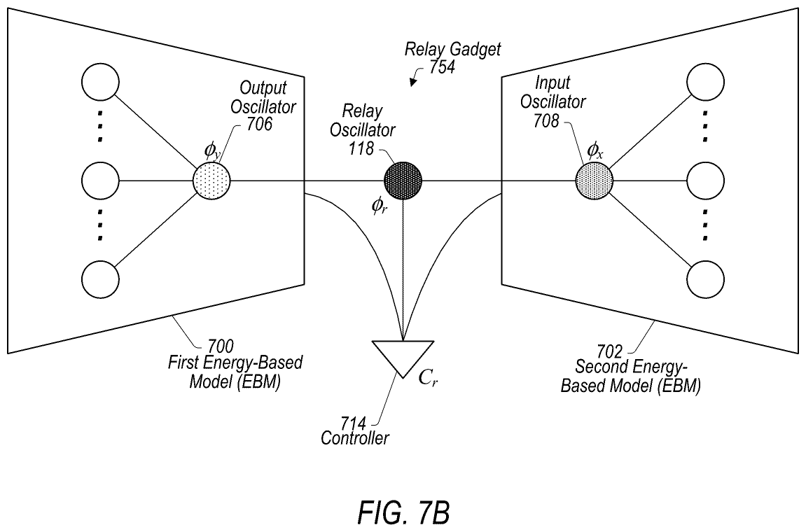

FIG. 7A is high-level diagram illustrating a first energy-based model (EBM) implemented using a thermodynamic chip, a second energy-based model (EBM) implemented using a thermodynamic chip, and a relay gadget implemented using a thermodynamic chip, wherein the relay gadget is configured to relay thermodynamic information between the first energy-based model (EBM) and the second energy-based model (EBM), according to some embodiments.

In some embodiments, a relay oscillator gadget, such as relay oscillator gadget 118, receives thermodynamic information from an input source, such as oscillator 706, and relays the thermodynamic information to an output destination, such as oscillator 708. In some embodiments, the oscillator 706 may be an output oscillator 706 of a first energy-based model (EBM) 700 and the oscillator 708 may be an input oscillator 708 of a second energy-based model (EBM) 702. In some embodiments, the thermodynamic information being relayed from the output oscillator 706 to the input oscillator 108 may be a position degree of freedom. As such, FIG. 7A shows an output position degree of freedom (ϕ_{y}) of the output oscillator 706 and an input position degree of freedom (ϕₓ) of the input oscillator 708, as well as a relay position degree of freedom (ϕᵣ) of the relay oscillator 718 and a bias position degree of freedom (ϕ_{b}) of the bias oscillator 712. Additionally, controller 714 is shown, which may be an on-chip controller. Controller 714 causes pulses to be emitted in a time dependent manner to orchestrate coupling of the relay oscillator 118 to the output oscillator 706, coupling of the relay oscillator 118 to the bias oscillator 712, adjustment of a mass or frequency of the relay oscillator 118, and a coupling of the relay oscillator 118 to the input oscillator 708. In some embodiments, the controller 714 may be pre-programmed to emit the relevant pulses and control signals in a time dependent sequence in order to execute a relay operation.

An example Hamiltonian of the coupled system shown in FIG. 7A is given by:

$${H}_{fan} = \frac{{π}_{r}^{2}}{2 {m}_{r} ( t )} + \frac{{π}_{y}^{2}}{2 {m}_{y}} + \frac{{π}_{x}^{2}}{2 {m}_{x}} + \frac{{π}_{b}^{2}}{2 {m}_{b}} + \frac{1}{2} {m}_{r} ( t ) {ω}_{r}^{2} ( t ) {ϕ}_{r}^{2} + \frac{1}{2} {m}_{b} {ω}_{b}^{2} {ϕ}_{b}^{2} + \frac{1}{2} {m}_{y} {{ω}_{y}^{2} ( {ϕ}_{y} - {y}_{e} )}^{2} + \frac{1}{2} {m}_{x} {ω}_{x}^{2} {ϕ}_{x}^{2} + {λ}_{A} ( t ) {( {ϕ}_{y} - {ϕ}_{r} )}^{2} + {λ}_{B} ( t ) {ϕ}_{b} {ϕ}_{r} + {λ}_{X} ( t ) {ϕ}_{r} {ϕ}_{X}$$

Note that the terms in the Hamiltonian including the λ_{A}, λ_{B}, and λ_{X} terms describe the coupling between the relay oscillators and the other three oscillators, e.g., the output oscillator 706, the bias oscillator 712, and the input oscillator 708. Also, note that all three coupling terms are time dependent, based on the λ_{A}, λ_{B}, and λ_{X} pulses controlled by controller 714. Additionally, note that the mass (or the frequency) of the relay oscillator 118 is time dependent, where the mass (or frequency) of the relay oscillator is also controlled by controller 714.

More particularly, the controller 714 emits pulses λ_{A} to couple the position degree of freedom (ϕ_{y}) of the output oscillator 706 to the position degree of freedom (ϕᵣ) of the relay oscillator 118. This coupling may remain turned on for some time. Then, once the coupling between the position degree of freedom (ϕ_{y}) of the output oscillator 706 and the position degree of freedom (ϕᵣ) of the relay oscillator 118 is turned off, the controller 714 causes pulses λ_{B} to be emitted to couple the position degree of freedom (ϕᵣ) of the relay oscillator 118 to the position degree of freedom (ϕ_{b}) of the bias oscillator 712, and simultaneously emits control signals to cause the mass of the relay oscillator 118 to be increased (or alternatively emits control signals to cause the oscillation frequency of the relay oscillator 118 to be tuned, for example decreased). When coupled to the relay oscillator 118, the bias position degree of freedom (ϕ_{b}) of the bias oscillator 712 acts as a bias to the relay oscillator 118 and helps to ensure that the relay position degree of freedom (ϕᵣ) of the relay oscillator 118 maintains its equilibrium value (that it has acquired from the output oscillator 706). After the relay oscillator 118 has reached an appropriately large mass (or tuned frequency), the controller 714 causes pulses λ_{X} to be emitted to couple the position degree of freedom (ϕᵣ) of the relay oscillator 118 (having the increased mass or tuned frequency) to the position degree of freedom (ϕ_{X}) of the input oscillator 708. Also, in some embodiments, the controller 714 may cause pulses λ_{X} and pulses λ_{B} to be emitted at the same time, such that the relay oscillator 118 is coupled to the bias oscillator 712 simultaneously with being coupled to the input oscillator 708. Note that in the illustration shown in FIG. 7A either of EBMs 700 or 702 may be an analog layer normalization gadget 102, that is to say the input to the relay oscillator may come from the analog layer normalization gadget 102 or the destination of the information being relayed may be the layer normalization gadget 102. FIG. 7A is illustrating a more general case for the relay gadget where the inputs and outputs are general EBMs, but it should be understood that the analog layer normalization gadget is a particular implementation of an EBM having an engineered potential that implements the layer normalization function.

In some embodiments the following pulse shapes may be used for λ_{A}, λ_{B}, and λ_{X}. Though in some embodiments, other suitable pulse shapes may be used.

$${λ}_{A} ( t ) = {λ}_{A} ( σ ( {k}_{A} ( t - {t}_{1} ) ) - σ ( {k}_{A} ( t - {t}_{2} ) ) )$$

$${λ}_{B} ( t ) = - {λ}_{B} σ ( {k}_{B} ( t - {t}_{1}^{( B )} ) ) + {λ}_{0}^{( B )}$$

$${λ}_{X} ( t ) = {λ}_{X} σ ( {k}_{X} ( t - {t}_{1}^{( X )} ) ) + {λ}_{0}^{( X )}$$

where σ(t) is the sigmoid function:

$$σ ( t ) = \frac{1}{1 + {e}^{- t}} .$$

In some embodiments, λ_{A}, λ_{B}, and λ_{X}, as well as k_{A}, k_{B}, and k_{X} may be tuned to improve results. Also, t₁, t₂, t₁^{(B)}, and t₁^{(X)} may be tuned.

Without loss of generality, the position degree of freedom of the output oscillator 706 (ϕ_{y}) is considered to have an equilibrium value (yₑ) (after energy-based model 700 has evolved for some time and reached a thermal equilibrium). Also, the position degree of freedom (ϕ_{y}) of the output oscillator 706 is considered to have a potential given by

$$\frac{1}{2} {m}_{y} {{ω}_{y}^{2} ( {ϕ}_{y} - {y}_{e} )}^{2} .$$

It should be noted in practice that the output oscillator 706 may be coupled to various other oscillators of the first energy-based model 700 (as shown in FIG. 7A) which would cause it to have the yₑ equilibrium value. Thus, to be more comprehensive,

$$\frac{1}{2} {m}_{y} {{ω}_{y}^{2} ( {ϕ}_{y} - {y}_{e} )}^{2}$$

may be replaced by a potential term that takes into account these couplings, such as

$$\frac{1}{2} {m}_{y} {{ω}_{y}^{2} ( {ϕ}_{y} - {y}_{e} )}^{2} + {\sum }_{j} {λ}_{Y}^{( j )} {φ}_{y} {φ}_{j} or$$

$$\frac{1}{2} {m}_{y} {ω}_{y}^{2} ( {φ}_{y} - {{y}_{e} )}^{2} + {λ}_{Y} {\sum }_{j} {{λ}_{Y}^{( j )} ( {φ}_{y} - {φ}_{j} )}^{2} ,$$

where the ϕⱼ degrees of freedom are degrees of freedom of other oscillators in the first energy-based model 700 that are coupled to the position degree of freedom (ϕ_{y}) of the output oscillator 706. However, this difference (or said another way, simplification) manifests itself in a slightly different value for the equilibrium value (yₑ), or depending on the couplings, may result in the same yₑ equilibrium value. But this simplification does not affect the equilibrium results of the relay oscillator 118. A similar issue applies to the input oscillator 708, which is also coupled to other oscillators of the second energy-based model 702. Also, in some embodiments, multiple relay oscillators 710 may be coupled to multiple input oscillators (e.g. additional input oscillators in addition to input oscillator 708). Note that the relay oscillator 118 and the relay gadget 704 impart the equilibrium value of the output oscillator to the input oscillator, such that the position degree of freedom (ϕ_{X}) of the input oscillator 708 inherits the same equilibrium value as the position degree of freedom (ϕ_{y}) of the output oscillator 706, e.g. the position it had when first coupled to the relay oscillator 118 of the relay gadget 704. As such, thermodynamic information is relayed from the output oscillator 706 to the input oscillator 708 while remaining in a thermodynamic state. For example, analog information is passed between the first energy-based model 700 and the second energy-based model 702 without requiring a measurement by a classical computing device. Further note, this is done in an analog way (as opposed to a digitization that would take place during readout and re-initialization).

For a system undergoing Langevin dynamics, the equation of motion of a given oscillator (k) is given by:

$$\frac{d {φ}_{k} ( t )}{d t} = \frac{\partial {H}_{fan}}{\partial {π}_{k}}$$

$${\frac{{π}_{k} ( t )}{d t} = - γ {π}_{k} ( t ) - \frac{\partial {H}_{fan}}{\partial {φ}_{k}} \vert}_{t} + \sqrt{2 {m}_{k} γ {k}_{B} T} \frac{d {W}_{t}}{d t}$$

where φ denotes the position degree of freedom of the oscillator and It denotes the momentum degree of freedom of the oscillator. Using the Hamiltonian for the coupled system shown in FIG. 7A (which is given further above) and the equations of motion for position and momentum given directly above, the equations of motions for the relay oscillator 118, output oscillator 106, the bias oscillator 712, and the input oscillator 708, are respectively given by:

### Equation of Motion for the Relay Oscillator:

$${m}_{r} ( t ) \frac{{d}^{2} {ϕ}_{r}}{d {t}^{2}} + \frac{d {m}_{r} ( t )}{dt} \frac{d {ϕ}_{r}}{dt} + γ {m}_{r} ( t ) \frac{d {ϕ}_{r}}{d t} = - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} ( t ) {ω}_{r}^{2} {ϕ}_{r} ) + \sqrt{2 {m}_{r} ( t ) {k}_{B} T} \frac{d {W}_{t}^{( r )}}{d t}$$

$$Or$$

$${m}_{r} ( t ) \frac{{d}^{2} {φ}_{r}}{d {t}^{2}} + \frac{d {m}_{r} ( t )}{dt} \frac{d {φ}_{r}}{dt} + γ {m}_{r} ( t ) \frac{d {φ}_{r}}{d t} = - ( - 2 {λ}_{A} ( t ) ( {φ}_{y} - {φ}_{r} ) - 2 {λ}_{B} ( t ) ( {φ}_{b} - {φ}_{r} ) + 2 {λ}_{X} ( t ) ( {φ}_{r} - {φ}_{x} ) + {m}_{r} ( t ) {ω}_{r}^{2} {φ}_{r} ) + \sqrt{2 {m}_{r} ( t ) {k}_{B} T} \frac{d {W}_{t}^{( r )}}{d t}$$

Depending on whether there is a linear or quadratic coupling.

### Equation of Motion for the Output Oscillator:

$${m}_{y} \frac{{d}^{2} {φ}_{y}}{d {t}^{2}} + γ {m}_{y} \frac{d {φ}_{y}}{d t} = - ( {λ}_{A} ( t ) {φ}_{y} + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

$$Or$$

$${m}_{y} \frac{{d}^{2} {φ}_{y}}{d {t}^{2}} + γ {m}_{y} \frac{d {φ}_{y}}{d t} = - ( 2 {λ}_{A} ( t ) ( {φ}_{y} - {φ}_{r} ) + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

Depending on whether there is a linear or quadratic coupling.

### Equation of Motion for the Bias Oscillator:

$${m}_{b} \frac{{d}^{2} {φ}_{b}}{d {t}^{2}} + γ {m}_{b} \frac{d {φ}_{b}}{d t} = - ( {λ}_{B} ( t ) {φ}_{r} + {m}_{b} {ω}_{b}^{2} {φ}_{b} ) + \sqrt{2 {m}_{b} {k}_{B} T} \frac{d {W}_{t}^{( b )}}{d t}$$

$$Or$$

$${m}_{b} \frac{{d}^{2} {φ}_{b}}{d {t}^{2}} + γ {m}_{b} \frac{d {φ}_{b}}{d t} = - ( - 2 {λ}_{B} ( t ) ( {φ}_{r} - {φ}_{b} ) + {m}_{b} {ω}_{b}^{2} {φ}_{b} ) + \sqrt{2 {m}_{b} {k}_{B} T} \frac{d {W}_{t}^{( b )}}{d t}$$

Depending on whether there is a linear or quadratic coupling.

### Equation of Motion for the Input Oscillator:

$${m}_{x} \frac{{d}^{2} {φ}_{x}}{d {t}^{2}} + γ {m}_{x} \frac{d {φ}_{x}}{d t} = - ( {λ}_{X} ( t ) {φ}_{r} + {m}_{x} {ω}_{x}^{2} {φ}_{x} ) + \sqrt{2 {m}_{x} {k}_{B} T} \frac{d {W}_{t}^{( x )}}{d t}$$

$$Or$$

$${m}_{x} \frac{{d}^{2} {φ}_{x}}{d {t}^{2}} + γ {m}_{x} \frac{d {φ}_{x}}{d t} = - ( - 2 {λ}_{X} ( t ) ( {φ}_{r} - {φ}_{x} ) + {m}_{x} {ω}_{x}^{2} {φ}_{x} ) + \sqrt{2 {m}_{x} {k}_{B} T} \frac{d {W}_{t}^{( x )}}{d t}$$

Depending on whether there is a linear or quadratic coupling.

Also, the time dependent mass of the relay oscillator 110 is given by:

$${m}_{r} ( t ) = {m}_{f}^{( r )} σ ( {k}_{r} ( t - {t}_{r} ) ) + {m}_{r} .$$

FIG. 7B is a high-level diagram similar to FIG. 7A, wherein the relay gadget does not include a bias oscillator, according to some embodiments.

In some embodiments, such as when the relay oscillator is configured to have a controllable time-dependent mass, the use of a bias oscillator may be omitted. For example, if the product of mass times frequency squared of a first oscillator is much larger than the product of mass times frequency of a second oscillator (that is coupled to the first oscillator) the position degree of freedom of the first oscillator (having the larger value for the product of mass times frequency squared) may be treated as a constant. Thus, for embodiments, wherein the mass of the relay oscillator can be increased such that the product of mass times frequency squared of the relay oscillator is sufficiently large, it may not be necessary to further use a bias oscillator.

More particularly, consider two oscillators (oscillator a and oscillator b) with position degrees of freedom ϕₐ and ϕ_{b}. Suppose that ϕ_{b} has equilibrium value b_{c}. Assume ϕ_{b} is a constant and consider the Hamiltonian:

$${H}_{1} = \frac{1}{2} {m}_{a} {ω}_{a}^{2} {φ}_{a}^{2} + {λφ}_{a} {b}_{c}$$

In this case, the expectation value of φₐ at thermal equilibrium is given by:

$$〈 {φ}_{a} 〉 = \frac{\int a {e}^{- β {H}_{1}} d a}{\int {e}^{- β {H}_{1}} d a} = \frac{λ {b}_{c}}{{m}_{a} {ω}_{a}^{2}}$$

Choosing λ=−mₐωₐ², it gives [symbol] ϕₐ [symbol] =b_{c}.

Also, considering the dynamics of ϕ_{b}. The Hamiltonian is:

$${H}_{2} = \frac{1}{2} {m}_{a} {ω}_{a}^{2} {φ}_{a}^{2} + \frac{1}{2} {m}_{b} {{ω}_{b}^{2} ( {φ}_{b} - {b}_{c} )}^{2} + {λφ}_{a} {φ}_{b}$$

Moreover, using H₂, [symbol] ϕₐ [symbol] is given by:

$$〈 {φ}_{a} 〉 = \frac{\int {ae}^{- β {H}_{2}} dadb}{\int {e}^{- β {H}_{2}} dadb} = - \frac{λ {b}_{c}}{{m}_{a} {ω}_{a}^{2} - \frac{{λ}^{2}}{{m}_{b} {ω}_{b}^{2}}} = \frac{{b}_{c}}{1 - \frac{{m}_{a} {ω}_{a}^{2}}{{m}_{b} {ω}_{b}^{2}}}$$

where λ is set such that λ=−mₐωₐ_{^{⋅}}². Note that if mₐωₐ_{^{⋅}}²<<m_{b}ω_{b}², then [symbol] ϕₐ [symbol] ≈b_{c}. As such as long as the mass times frequency squared of the oscillator a having position degree of freedom ϕₐ is much less than the mass times frequency squared of the oscillator b having position degree of freedom ϕ_{b}, the position degree of freedom ϕ_{b} can be treated as a constant, with the constant being the thermal equilibrium value of ϕ_{b}.

Said another way, if the product of mass times frequency squared of the relay oscillator 118 is increased to be sufficiently large, then the inherited equilibrium value acquired from the output oscillator 706 can be treated as a constant, while held by the relay oscillator 118. Also, as long as the product of mass times frequency squared of the relay oscillator 118 is sufficiently large as compared to the corresponding value of mass times frequency squared of the input oscillator 708, the position degree of freedom of the relay oscillator may be treated as a constant, such that it relays the held equilibrium value acquired from the output oscillator 706 of the first EBM 700 to the input oscillator 708 of the second EBM 702.

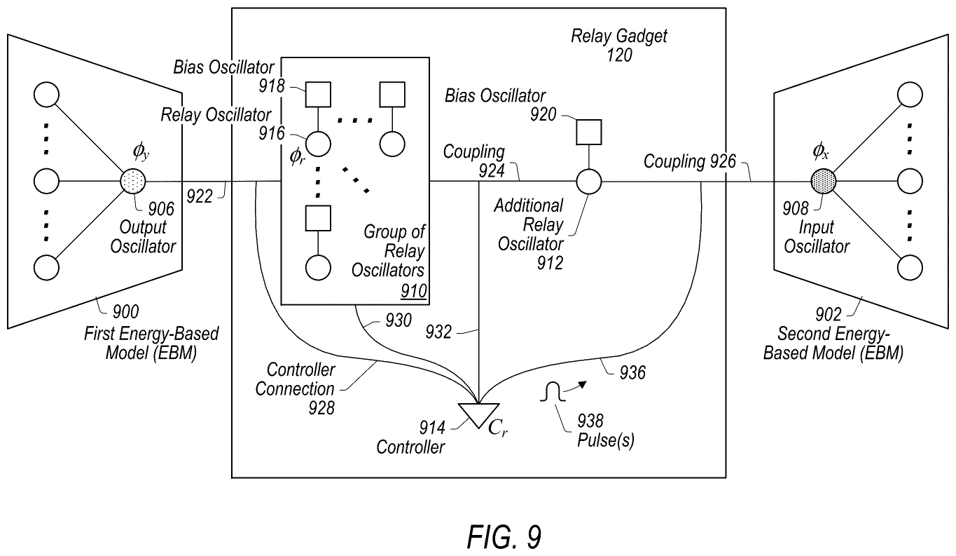

Note that the relay oscillators used in the relay gadget configurations shown in FIGS. 9-12, include bias oscillators. However, in some embodiments, similar configurations may be used that do not include bias oscillators. For example, relay oscillators as shown in FIG. 7A or as shown in FIG. 7B may be used to construct the relay gadgets shown in FIGS. 9-12.

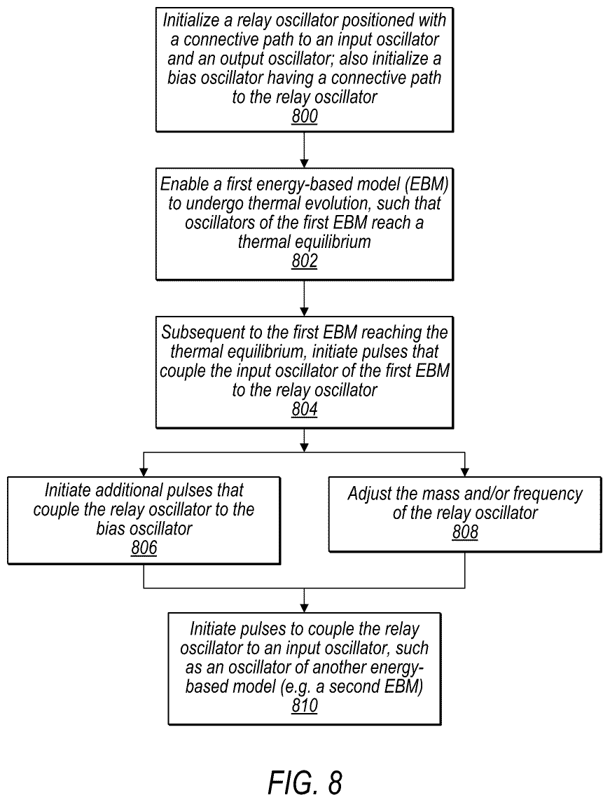

FIG. 8 is a high-level flowchart illustrating a process of relaying thermodynamic information between an output oscillator, such as of a first energy-based model (EBM), and an input oscillator, such as of a second energy-based model (EBM), according to some embodiments.

At block 800 a relay oscillator is initialized, wherein the relay oscillator is positioned such that it has connectivity to an output oscillator, such as output oscillator 706 of energy-based model 700, and has connectivity to an input oscillator, such as input oscillator 708 of energy-based model 702. Additionally, a bias oscillator is initialized, wherein the bias oscillator has connectivity to the relay oscillator. For example, bias oscillator 712 may be initialized and is positioned in a way that it can be coupled to relay oscillator 118.

At block 802, the first energy-based model comprising the output oscillator, such as energy-based model 700 that includes output oscillator 706, is enabled to undergo thermal evolution such that the energy-based model evolves according to Langevin dynamics. The evolution may be enabled to occur for an amount of time such that the first energy-based model reaches a thermal equilibrium. As an example, the first energy-based model may represent a trained model that is configured to perform inference, and at least some oscillators of the first energy-based model may be clamped to input data, wherein inference results are represented by other oscillators of the first energy-based model subsequent to the thermal evolution. For example, output oscillator 706 may represent the results of a computation performed by the energy-based model 700 that are to be relayed as input data to the second energy-based model 702.

At block 804, once the oscillators of the first energy-based model (e.g. energy-based model 700) have reached thermal equilibrium, the controller 714 initiates pulses (e.g. λ_{A}(t) pulses) to cause the output oscillator 706 to be coupled to the relay oscillator (e.g. relay oscillator 118).

At block 806, the controller 714 initiates additional pulses (e.g., λ_{B}(t) pulses) that cause the relay oscillator to be coupled to the bias oscillator. Recall that initially the relay oscillator 118 may have a small mass and/or frequency combination, e.g., small relative to the product of mass times frequency squared of the output oscillator 706. Because the relay oscillator has a small product of mass times frequency squared, the relay oscillator more readily takes on the position of the output oscillator (for example, as opposed to the relay oscillator pulling the output oscillator to take on the relay oscillator's position). However, due to the relatively small mass times frequency squared of the relay oscillator, if left alone the relay oscillator would quickly lose the recently inherited position, inherited from the output oscillator. To avoid this, the relay oscillator is coupled to the bias oscillator 712 at or near the same time as the relay oscillator is un-coupled from the output oscillator 706. The relay oscillator may also be coupled to the bias oscillator at or near the same time it is coupled to the input oscillator 708. Coupling the relay oscillator to the bias oscillator helps the relay oscillator to maintain the acquired thermal information (e.g., position degree of freedom, or, in some embodiments, momentum degree of freedom) the relay oscillator has acquired from the output oscillator. Also, while coupled to the bias oscillator and prior to being coupled to the input oscillator of the next EBM, a mass and/or frequency of the relay oscillator is adjusted.

For example, at block 808, the controller 714 causes control signals to be emitted that cause the mass (or frequency) of the relay oscillator to be adjusted. The mass of the relay oscillator may be proportional to capacitance of a circuit used to implement the relay oscillator; a Cooper-pair box arrangement may be used to implement a time dependent capacitance in the circuit (e.g. where the capacitance corresponds to mass). In such embodiments, the controller 714 is configured to emit control signals to cause the Cooper-pair box to increase the capacitance of the relay oscillator circuit. However, in other embodiments, mass may be kept constant, but instead frequency of the relay oscillator may be adjustable as a result of a time-dependent flux element of a circuit used to implement the relay oscillator. For example, a current inducing flux element may be added to the relay oscillator circuit. In such embodiments, controller 714 may emit control signals that cause the flux of the relay oscillator to be tuned (where flux corresponds to frequency). In some embodiments blocks 806 and 808 are performed concurrently.

At block 810, the controller 714 initiates another set of one or more pulses (e.g., λ_{X}(t) pulses) to couple the relay oscillator to the input oscillator, such as input oscillator 708. The bias oscillator 712 may remain coupled to the relay oscillator 118 when the relay oscillator 118 is coupled to the input oscillator 708. Note that since the relay oscillator has had its mass (and/or frequency) adjusted prior to the coupling to the input oscillator, and since the relay oscillator remains coupled to the bias oscillator, the relay oscillator has a large value of the product of mass times frequency squared relative to the input oscillator and therefore causes the input oscillator to take on the position of the relay oscillator, which corresponds to the position of the output oscillator. In this way, the relay gadget 704 relays analog oscillator degree of freedom information (e.g. thermodynamic information) from the output oscillator to the input oscillator, without having to convert the thermodynamic information into classical form.

In some embodiments, a relay gadget, such as relay gadget 704, may perform steps similar to those described in FIG. 8 in order to relay position degree of freedom thermodynamic information, momentum degree of freedom thermodynamic information, and/or force/acceleration degree of freedom thermodynamic information.

In some embodiments, a relay gadget, such as relay gadget 704 may be used to store thermodynamic information, for example in the relay oscillator 118. Also, in some embodiments, multiple relay gadgets may be used to form a thermodynamic network between thermodynamic components. Also, in some embodiments, a relay gadget may be used to perform conditional sampling, such as Gibbs sampling.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

In some embodiments, it is desired to transfer an expectation value of one energy-based model (EBM) to another EBM, such as from an output of analog layer normalization gadget 102 to an input of another EBM. In some embodiments an instantaneous sample value may be transferred from an output oscillator of one EBM (such as from a given input/output oscillator 112 of analog layer normalization gadget 102) to an input oscillator of another EBM. The instantaneous sample value of an output oscillator of a given EBM will follow a probability distribution associated with the potential well of the output oscillator and couplings of the output oscillator with the one or more oscillators belonging to the first EBM. An instantaneous sample value of the state of the output oscillator may be any possible value within the bounds of the potential well and respective couplings. In some instances, the instantaneous sample value of the output oscillator may be far off from the expectation value (e.g. due to thermodynamic fluctuations, anharmonic potentials, multiple well potentials, the coupling between the output oscillator with other oscillators belonging to a shared EBM, or a combination of factors). Furthermore, the output oscillator of an EBM may hop between wells of a potential, thus the expectation value may not be a probable outcome of an instantaneous sample of the output oscillator. To avoid these issues, in some embodiments expectation values may be stored instead of sample values and relayed as inputs to other EBMs.

In some embodiments, to enable an expectation value of an output of an EBM to be used as an input to a subsequent EBM in a fully analogue fashion (e.g. without the use of measurements), two or more relay oscillators may be used. In some embodiments, an expectation value is derivable from one or more sample values. In some embodiments, relay oscillators may be oscillators which may be arranged between the output of a given EBM and the input of an additional EBM in such a way that their state may be configured to take on a sample value of the output oscillators of a given EBM. In some embodiments, sample values may be collected in such a way (e.g. spatial or temporal arrangement of relay oscillators as described below) that a close approximation of an expectation value of an output of a given EBM may be represented on one or more relay oscillators. Classical controllers may be used to turn the couplings on and off between the output oscillators and relay oscillators, between respective relay oscillators, as well as to make the masses and frequencies of the relay oscillators time dependent. Nevertheless, measurements may not be required, and the timing of the operations may be computed during a compilation step.

In some embodiments, a relay gadget may include a group of one or more relay oscillators and an additional relay oscillator. One or more relay oscillators of the group of relay oscillators may be coupled to an output oscillator of a first EBM. The one or more relay oscillators may be coupled in such a way that respective sample values of the output oscillator of the first EBM, wherein the output oscillator has progressed through thermodynamic evolution, may be stored on respective ones of the relay oscillators of the first group of one or more relay oscillators. An additional relay oscillator may be coupled to one or more of the relay oscillators, wherein the coupling enables the additional relay oscillator to take on an expectation value of the output oscillator, wherein the expectation value is derivable based at least in part on the sample values. In some embodiments, bias oscillators may be used. In some embodiments, bias oscillators may not be used. For simplicity, embodiments are given with bias oscillators, but it should be understood that is some embodiments bias oscillators may not be used for each relay oscillator of a relay gadget, however, that does not limit the embodiments to only one way or the other.

In some embodiments, thermodynamic information is relayed from a first energy-based model (EBM) 900 to a second energy-based model (EBM) 902 via relay gadget 120. The thermodynamic information of EBM 900 is outputted via output oscillator 906 and inputted into input oscillator 908 via relay gadget 120. The thermodynamic information may include, for example, samples of thermodynamic equilibrium of output oscillator 906, or the expectation value of the output oscillator 906. The expectation value is at least derivable based on samples values of the output oscillator 906. Output oscillator 906 may be governed by a potential wherein the potential follows a single-well potential, double-well potential, multi-well potential, or any generic potential that may be engineered. The output oscillator 906 may also be coupled to other oscillators belonging to EBM 900. More specifically, output oscillator 906 may be an input/output oscillator 112 of analog SoftMax gadget 106.

In some embodiments, an expectation value of one or more degrees of freedom of output oscillator 906 may be influenced by a potential of output oscillator 906 as well as couplings between output oscillator 906 and one or more oscillators belonging to first energy-based model 900. Potentials governing the dynamics of the output oscillator 906 may have multiple wells. With generic arbitrary potentials (e.g. multiple wells) and coupling between output oscillator 906 and one or more oscillators belonging to first energy-based model 900, the position degrees of freedom of the output oscillators can hop between wells. As described herein, a relay gadget provides a solution to approximate an expectation value of the output oscillator. For example, using an approximated expectation value in forwards and backwards propagation may provide better results than using a sample value, as the expectation value better represents the state of the oscillator whose degree of freedom value is being relayed to a second oscillator.

Relay gadget 120 comprises a group of relay oscillators 910 and an additional relay oscillator 912. The group of relay oscillators 910 comprises one or more relay oscillators arranged with respective bias oscillators (e.g., relay oscillator 916 arranged with bias oscillator 918). As described later, relay oscillators in oscillator group 910 may be configured and coupled in various ways (e.g. temporally and spatially) to transfer thermodynamic information. The additional relay oscillator 912 is connected to bias oscillator 920. As discussed later, the additional relay oscillator 912 may be configured and coupled in various ways to transfer thermodynamic information. For example, the group of relay oscillators 910 transfers thermodynamic information to additional relay oscillator 912 via coupling 924. Coupling 924 may be controlled by on-chip classical controller 914.

Output oscillator 906 is coupled to the one or more relay oscillators of the group of relay oscillators 910 via on-chip classical controller 914. On-chip classical controller 914 may send a pulse or a group of pulses to cause couplings between oscillators (e.g., coupling between output oscillator 906 and relay oscillator 916) or relay oscillators like 916 and a bias oscillator like 918 via pulses 930. Coupling is represented by coupling 922, 924, 926 and oscillators may be coupled or not coupled. When coupling is on, parameters of respective coupled oscillators affect the other oscillator it is coupled to. Couplings between oscillators within the group of relay oscillators 910 are not expressly shown in FIG. 9 to emphasize that the coupling may take different configurations (e.g. temporal or spatial configurations as detailed below). Nevertheless, on-chip classical controller 914 may cause a first set of one or more pulses to be emitted through controller connection 928, wherein the first set of pulses couples one or more relay oscillators of the group of relay oscillators 910 to the output oscillator 906 (e.g., turn on coupling 922). The on-chip classical controller 914 is further configured to cause a second set of one or more pulses to be emitted through path 932, wherein the second set of pulses couples one or more relay oscillators of the group of relay oscillators 910 to the additional relay oscillator 912 (e.g., turn on coupling 924). The on-chip classical controller 914 is further configured to cause a third set of one or more pulses (for example, set of pulses 938) to be emitted, wherein the third set of pulses 938 couples the additional relay oscillator 912 to the input oscillator 108 (e.g., turn on coupling 926).

In some embodiments, an additional relay oscillator 912 takes on an expectation value of an output oscillator 906 based at least in part on a coupling or couplings between a group of relay oscillators 910, wherein respective relay oscillators of group 910 comprise respective sample values of the output oscillator 906. The additional relay oscillator 912 may take on the expectation value of output oscillator 906 based at least on respective sample values taken on by respective relay oscillators. Furthermore, additional relay oscillator 912 may transfer the taken on expectation value to input oscillator 908 via controller 914 causing coupling 926 to turn on.

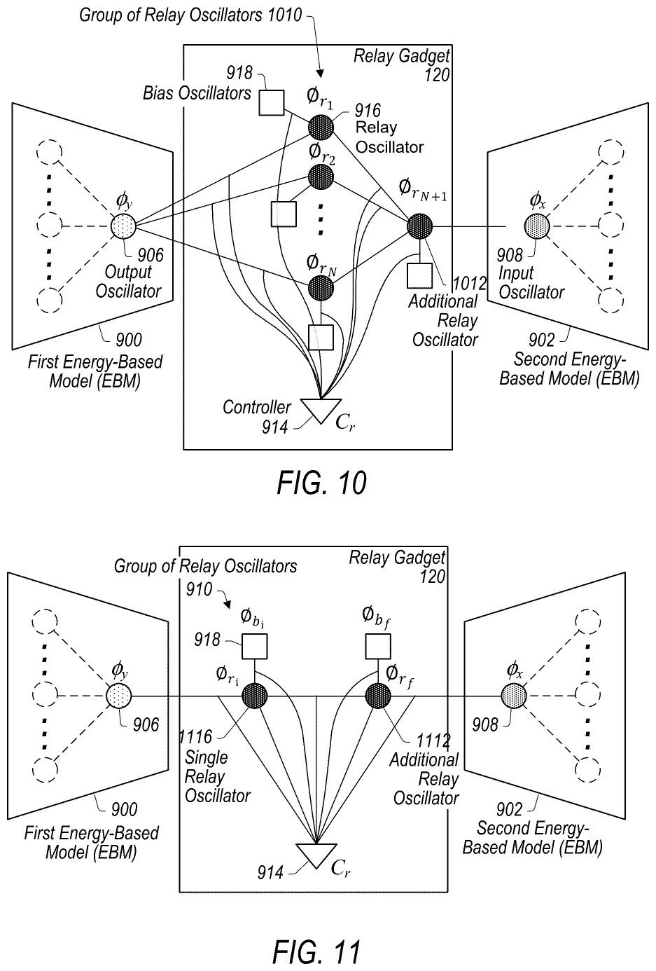

FIG. 10 is a high-level diagram illustrating a spatial analogue relay gadget, wherein respective ones of relay oscillators of a group of relay oscillators are configured to store respective sample values of an output oscillator, according to some embodiments.

In some embodiments, controller 914 sends a first set of one or more pulses wherein the first set of pulses causes output oscillator 906 of first energy-based model (EBM) 900 to be coupled to at least one or more relay oscillators {ϕᵣ_{₁}, ϕᵣ_{₂}, . . . ϕᵣ_{_{N}}}, in the group of relay oscillators 1010. The group of relay oscillators 1010 comprises a plurality of relay oscillators, wherein respective relay oscillators {ϕᵣ_{₁}, ϕᵣ_{₂}, . . . ϕᵣ_{_{N}}}, are configured to store a sample of the output oscillator 906 based at least in part on respective couplings between the respective ones of the relay oscillators (e.g., 916) of the group of relay oscillators 1010 and the output oscillator 906. The on-chip classical controller 914 is further configured to cause another set of one or more pulses to be emitted, wherein the other set of pulses turns off the respective couplings between the output oscillator 906 and the respective ones of the relay oscillator of the group of relay oscillators 1010 at different times. This may allow different samples of the output oscillator 906 to be stored on the respective ones of the relay oscillators {ϕᵣ_{₁}, ϕᵣ_{₂}, . . . ϕᵣ_{_{N}}}.

On-chip classical controller 914 may be further configured to cause a second set of one or more pulses to be emitted, wherein the second set of pulses turns on the coupling between respective ones of the relay oscillators with sample values of the output oscillator 906 to an additional relay oscillator 1012. The coupling is configured to transfer an approximation of the expectation value of output oscillator 906 based at least in part on the sample values stored on respective relay oscillators in the first group of relay oscillators 1010. Once the additional relay oscillator 1012 is tuned to the expectation value of output oscillator 906, controller 914 may cause a set of one or more pulses that may cause the additional relay oscillator 1012 to be coupled to input oscillator 908. For ease of illustration a version that includes bias oscillators is shown. However, it should be understood that in some embodiments bias oscillators may be omitted.

FIG. 11 is a high-level diagram illustrating a temporal analogue relay gadget, wherein a group of relay oscillators comprises a single relay oscillator, according to some embodiments.

In some embodiments, the group of relay oscillators 910 comprises a single relay oscillator 1116. The single relay oscillator 1116 is configured to store a sample of the output oscillator 906 based at least in part on the coupling between the single relay oscillator 1116 and the output oscillator 906. The coupling between output oscillator 906 and single relay oscillator 1116 is caused by a first set of one or more pulses emitted from on-chip classical controller 914. The on-chip classical controller 914 is configured to cause a second set of one or more pulses to be emitted, wherein the second set of pulses causes the single relay oscillator 1116 to be coupled to additional relay oscillator 1112. The sequence of emitting the first set of pulses and then emitting the second set of pulses may be repeated numerous times. Each instance the sequence of the sequential sets of pulses is emitted, the position of additional relay oscillator 1112 is incrementally adjusted. Each adjustment may converge the additional relay oscillator 1112 to the expectation value of output oscillator 906. For ease of illustration a version that includes bias oscillators is shown. However, it should be understood that in some embodiments bias oscillators may be omitted.

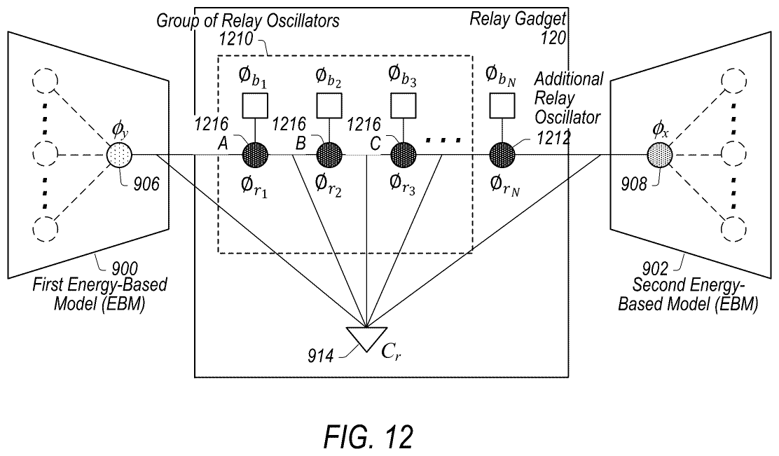

FIG. 12 is a high-level diagram illustrating a series analogue relay gadget, wherein a group of relay oscillators comprises a plurality of relay oscillators arranged in series, according to some embodiments.

FIG. 12 shows a drawing of a series analogue relay gadget 1204. The group of relay oscillators 910 comprises a plurality of relay oscillators {ϕᵣ_{₁}, ϕᵣ_{₂}, . . . } (e.g. relay oscillator 1216A, 1216B, 1216C) arranged one after another in series. Each relay oscillator has a product of mass and frequency squared. The first relay oscillator 1216A, ϕᵣ_{₁}, has the smallest product of mass and frequency squared. The next relay oscillator 1216B, ϕᵣ_{₂}, has a product of mass and frequency squared larger than the previous relay oscillator 1216A, ϕᵣ_{₁}. This trend of increasing the product of mass and frequency squared continues for each subsequent relay oscillator in the group of relay oscillators 910. As last in the chain of relay oscillators, the additional relay oscillator 1212 has the largest product of mass and frequency squared. The couplings between relay oscillators and the coupling between the output oscillator 906 and the first relay oscillator 1216A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 906. In this manner, additional relay oscillator 1212 approximates an expectation value of input oscillator 906. At this point, coupling between the additional relay oscillator 1212 and input oscillator 908 may be turned on and the thermodynamic information may be transferred to input oscillator 908. The number of relay oscillators and the timing of coupling may be chosen beforehand and optimized for a desired precision or accuracy of the expectation value of the output relay oscillator. For ease of illustration a version that includes bias oscillators is shown. However, it should be understood that in some embodiments bias oscillators may be omitted.

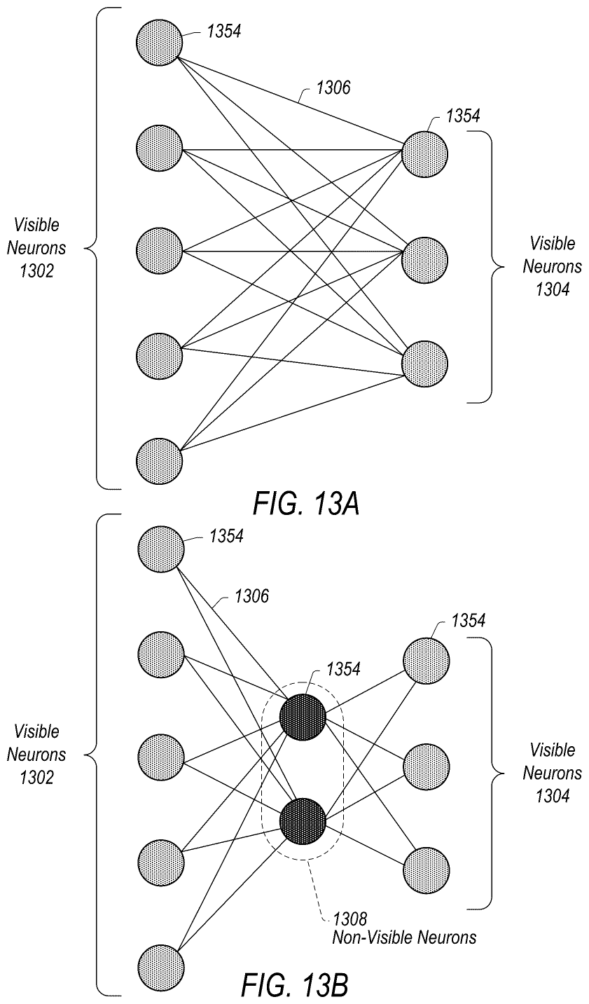

FIG. 13A illustrates example couplings between visible neurons of an energy-based model (EBM), according to some embodiments.

In some embodiments, input neurons and output neurons of an energy-based model, such as visible neurons 1302 and visible neurons 1304, may be directly linked via connected edges 1306. As shown in FIG. 13A, a given visible neuron 1302 of the five shown in the figure is connected, via edges 1306, to each of the respective three visible neurons 1304. A person having ordinary skill in the art should understand that FIG. 13A is meant to represent example embodiments of a graph architecture implemented using a thermodynamic chip that may be applied and that specific numbers of visible neurons 1302 and/or visible neurons 1304 shown in the figure are not meant to be restrictive. Additional configurations combining more/less visible neurons 1302 and/or visible neurons 1304 are also encompassed by the discussion herein. In addition, recall that neurons are logical representations of physical oscillators, such that, when describing neurons in FIGS. 13A and 13B, it should be understood that neurons and edges are implemented using oscillators and couplings.

FIG. 13B illustrates example couplings between visible neurons and non-visible neurons (e.g., hidden neurons) of an energy-based model (EBM), according to some embodiments.

In some embodiments, FIG. 13B may resemble additional example embodiments of an energy-based model architecture implemented using a thermodynamic chip. As shown in the figure, additional non-visible neurons 1308 may be used, which are respectively coupled, via edges 1306, to both visible neurons 1302 and to visible neurons 1304. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1306, may be implemented between visible neurons 1302 and visible neurons 1304, but rather connections are routed firstly via non-visible neurons 1308, as shown in FIG. 13B. Couplings between visible and non-visible neurons may be additionally referred to herein as “layers” of a given energy-based model architecture that is implemented using a thermodynamic chip, according to some embodiments.

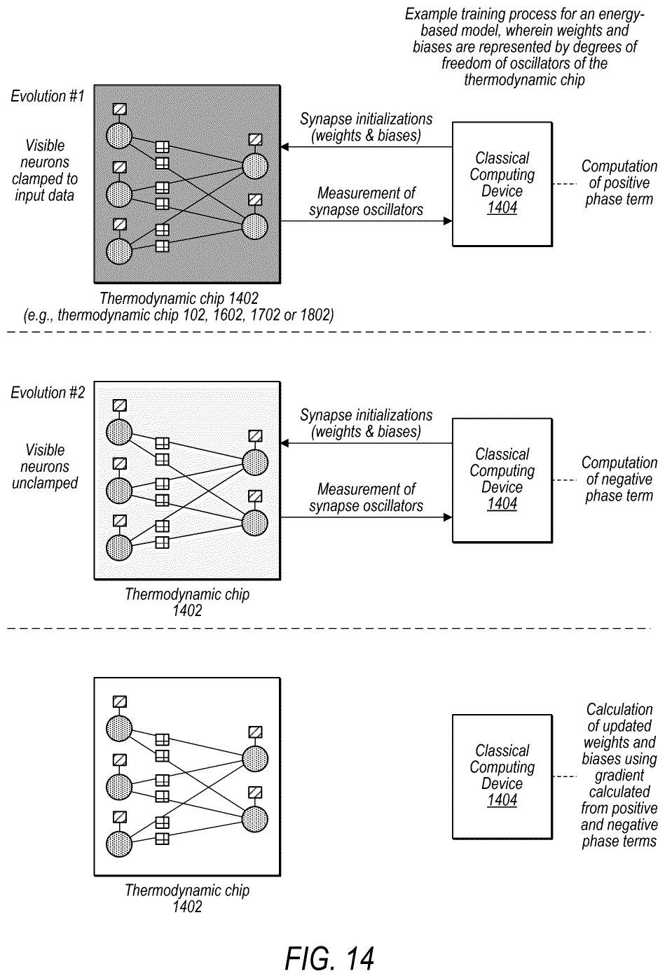

FIG. 14 is high-level diagram illustrating a process of determining weights and biases to be used in an energy-based model (EBM), wherein the weights and biases are determined using measurement values for synapse oscillators, according to some embodiments.

As shown in FIG. 14, in a first evolution, visible neurons of an energy-based model implemented on a thermodynamic chip 1402 may be clamped to input data. For example, multiple mini-batches of input data may be clamped to visible neurons for multiple evolutions used to generate a first set of measurements used to compute a positive phase term. For example, the measurements may be used by classical computing device 1404 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 1404 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases.

If not sufficiently trained, the process may continue with additional iterations of determining updated weights and biases.

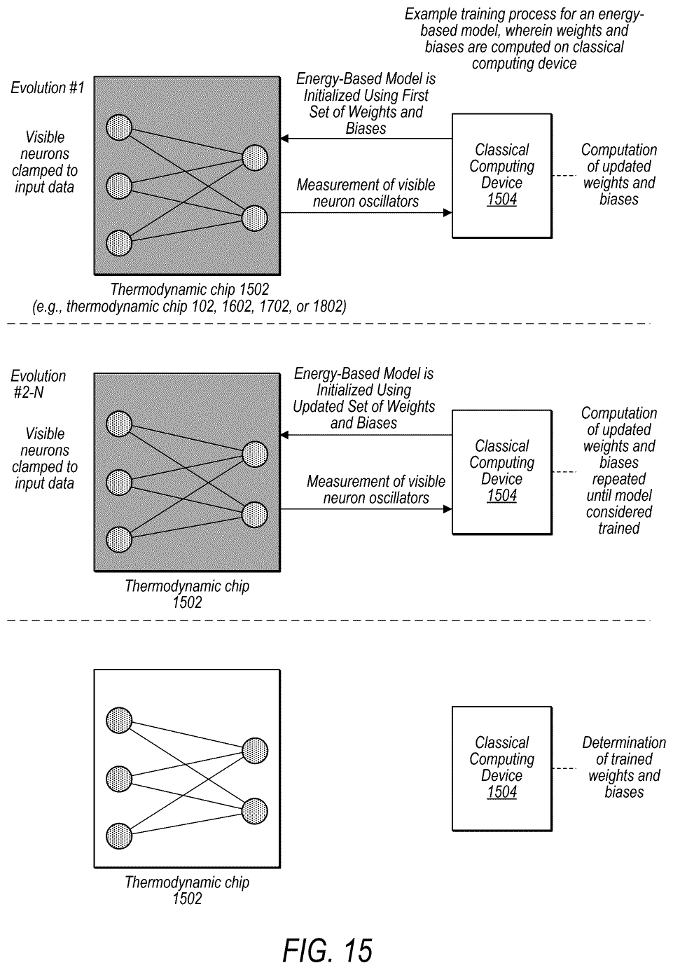

FIG. 15 is high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 1504 based on inference measurements from thermodynamic chip 1502. For example, inference values may be compared to training data values, and new weights and biases may be iteratively computed until the inference values closely correspond to the training data. As can be seen in FIG. 15, in some embodiments the synapse oscillator may be omitted as degrees of freedom of the energy-based model. For example, when a classical computing device is used to iteratively determine the weight and bias values.

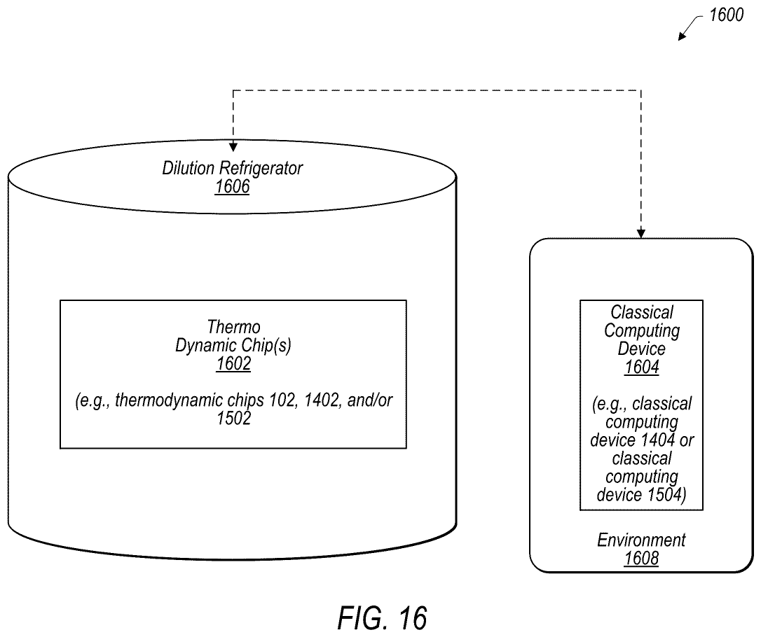

FIG. 16 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device in an environment external to the dilution refrigerator, according to some embodiments.

In some embodiments, a neuro-thermodynamic computing system 1600 (as shown in FIG. 16) may be used to implement the various embodiments shown in FIGS. 1-15 and may include one or more thermodynamic chip(s) 1602 placed in a dilution refrigerator 1606. In some embodiments, classical computing device 1604 may control temperature for dilution refrigerator 1606, and/or perform other tasks, such as helping to drive a pulse drive to change respective hyperparameters of the given system and/or perform measurements, such as those shown in FIGS. 1-15. Also, the classical computing device 1604 may perform other simple computing operations, such as are needed to determine updated weights and biases.

In some embodiments, classical computing device 1604 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1600. For example, such devices may be used to tune hyperparameters of the given thermodynamic system, etc. as well as perform part of the calculations necessary to determine updated weights and biases. In some embodiments, the classical computing device 1604 may be placed in an environment 1606 outside of the dilution refrigerator 1606.

As shown in FIG. 16, in embodiments where more than one thermodynamic chip is used with a relay gadget, multiple ones of the thermodynamic chips and the relay gadget may be placed in the same dilution refrigerator 1606.

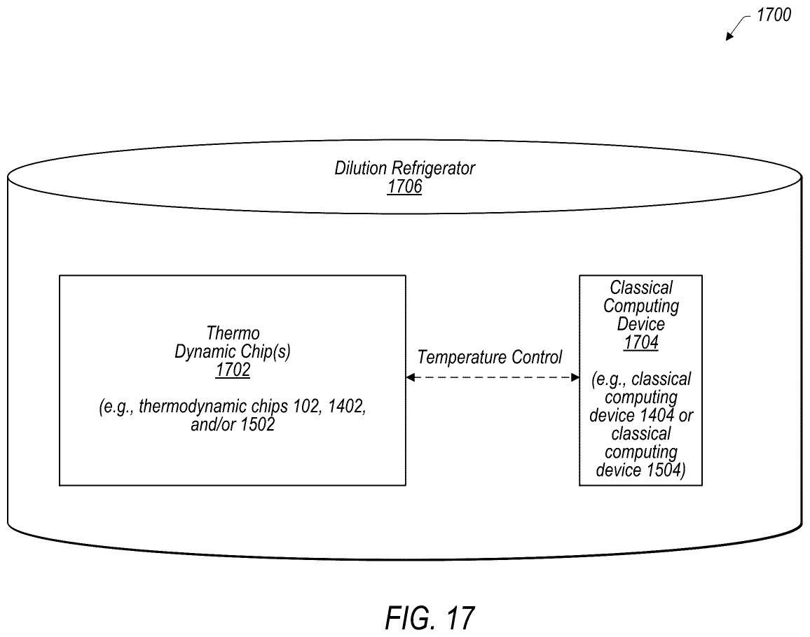

FIG. 17 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1700, may be included in a dilution refrigerator with the thermodynamic chip. For example, neuro-thermodynamic computer 1700 includes both thermodynamic chip 1702 and classical computing device 1704 in dilution refrigerator 1706.

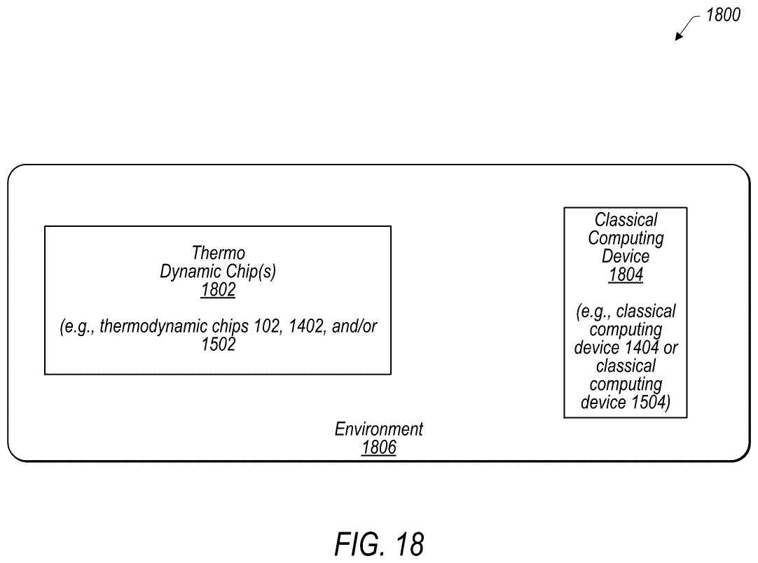

FIG. 18 is high-level diagram illustrating an example neuro-thermodynamic computer comprising one or more thermodynamic chips (e.g., that implement respective energy-based models (EBMs) and a relay gadget) coupled to a classical computing device in an environment other than a dilution refrigerator, according to some embodiments.

Also, in some embodiments, a neuro-thermodynamic computer, such as neuro-thermodynamic computer 1800, may be implemented in an environment other than a dilution refrigerator. For example, neuro-thermodynamic computer 1800 includes thermodynamic chip(s) 1802 and classical computing device 1804, in environment 1806. In some embodiments, environment 1806 may be temperature controlled and, the classical computing device (or other device) may control the temperature of environment 1806 in order to achieve a given level of evolution according to Langevin dynamics.

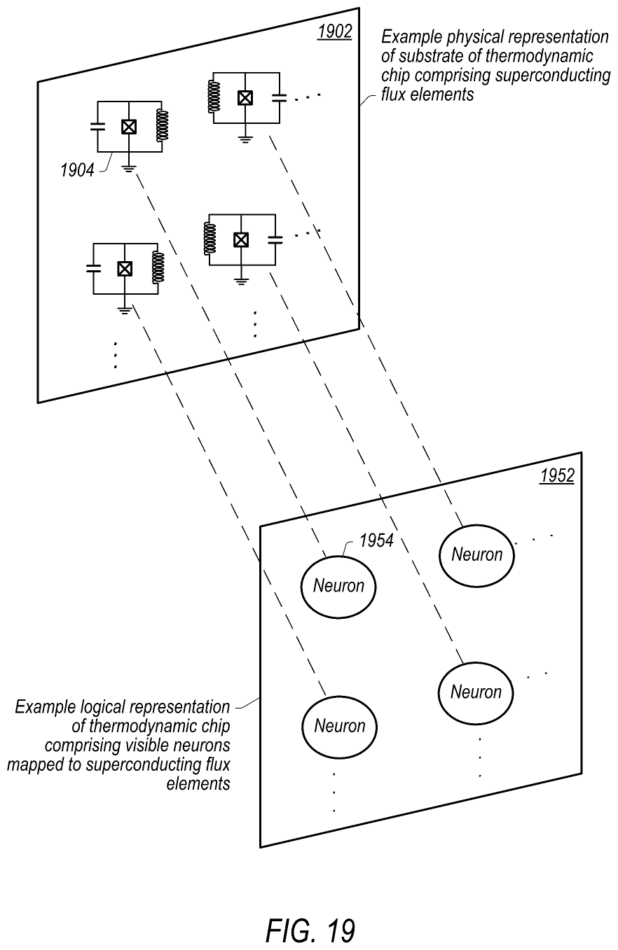

FIG. 19 is a high-level diagram illustrating oscillators included in a substrate of the thermodynamic chip and mapping of the oscillators to logical neurons of the thermodynamic chip, according to some embodiments.

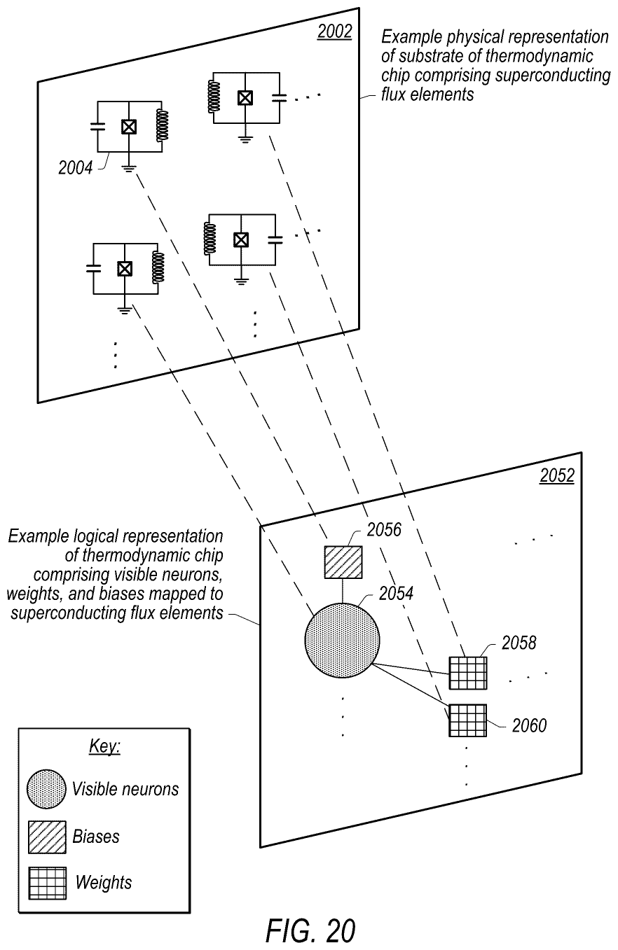

In some embodiments, a substrate 1902 may be included in a thermodynamic chip, such as any one of the thermodynamic chips described above. Oscillators 1904 of substrate 1902 may be mapped in a logical representation 1952 to neurons 1954, as well as weights and biases (shown in FIG. 20). In some embodiments, oscillators 1904 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1904. In some embodiments, the oscillators 1904 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 19 for oscillator 1904. However, in some embodiments, generally speaking various non-linear flux loops may be used to implement the oscillators 1904, such as those having single-well potential, double-well potential, or various other potentials, such as a potential somewhere between a single-well potential and a double-well potential.

FIG. 20 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 19 for ease of illustration, respective ones of the visible neurons 1954 of FIG. 19 may each have an associated bias, and edges connecting the neurons 1954 may have associated weights. Each of the weights and biases may be mapped to oscillators in the thermodynamic chip, as well as the visible (and non-visible) neurons being mapped to oscillators in the thermodynamic chip. For example, FIG. 20 shows a portion of a thermodynamic chip, wherein weights and biases associated with a given neuron 2054 are shown. For example, bias 2056 may be a bias value for visible neuron 2054 and weights 2058 and 2060 may be weights for edges formed between visible neuron 2054 and other visible neurons of the thermodynamic chip. As shown in FIG. 20, each of the chip elements (visible neuron 2054, bias 2056, weight 2058, and weight 2060) may be mapped to separate ones of oscillators 2004. This may allow the visible neurons (and/or hidden neurons), weights, and biases to have independent degrees of freedom within a given thermodynamic chip that can separately evolve.

In some embodiments, oscillators associated with weights and biases, such as bias 2056 and weights 2058 and 2060, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

### Illustrative Computer System

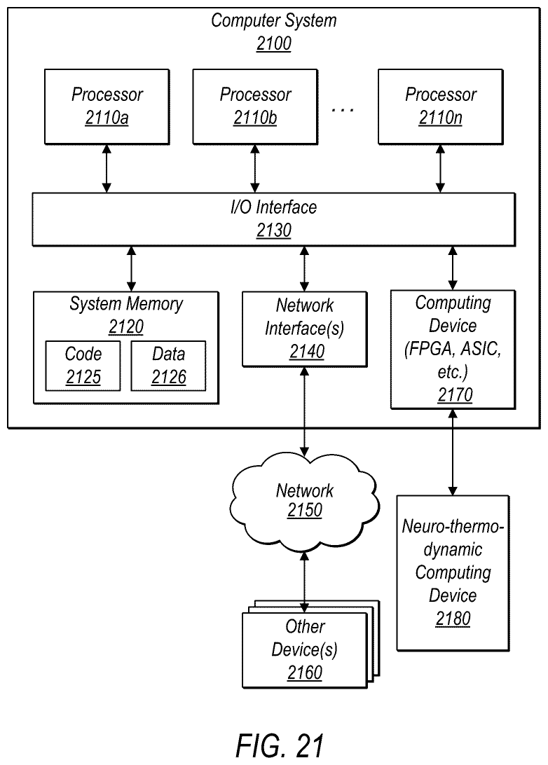

FIG. 21 is a block diagram illustrating an example computer system that may be used in at least some embodiments. In some embodiments, the computing system shown in FIG. 21 may be used, at least in part, to implement any of the techniques described above in FIGS. 1-20. Furthermore, computer system 2100 may be configured to interact and/or interface with neuro-thermodynamic computing device 2180, according to some embodiments.

In the illustrated embodiment, computer system 2100 includes one or more processors 2110 coupled to a system memory 2120 (which may comprise both non-volatile and volatile memory modules) via an input/output (I/O) interface 2130. Computer system 2100 further includes a network interface 2140 coupled to I/O interface 2130. Classical computing functions may be performed on a classical computer system, such as computing computer system 2100.

Additionally, computer system 2100 includes computing device 2170 coupled to thermodynamic chip 2180. In some embodiments, computing device 2170 may be a field programmable gate array (FPGA), application specific integrated circuit (ASIC) or other suitable processing unit. In some embodiments, computing device 2170 may be a similar computing device as described in FIGS. 1-20, such as classical computing devices used to control a thermodynamic chip. In some embodiments, neuro thermodynamic computing device 2180 may be a similar neuro thermodynamic computing device as described in FIGS. 1-20, such as neuro thermodynamic computing devices implemented using thermodynamic chips.

In various embodiments, computer system 2100 may be a uniprocessor system including one processor 2110, or a multiprocessor system including several processors 2110 (e.g., two, four, eight, or another suitable number). Processors 2110 may be any suitable processors capable of executing instructions. For example, in various embodiments, processors 2110 may be general-purpose or embedded processors implementing any of a variety of instruction set architectures (ISAs), such as the x86, PowerPC, SPARC, or MIPS ISAs, or any other suitable ISA. In multiprocessor systems, each of processors 2110 may commonly, but not necessarily, implement the same ISA. In some implementations, graphics processing units (GPUs) may be used instead of, or in addition to, conventional processors.

System memory 2120 may be configured to store instructions and data accessible by processor(s) 2110. In at least some embodiments, the system memory 2120 may comprise both volatile and non-volatile portions; in other embodiments, only volatile memory may be used. In various embodiments, the volatile portion of system memory 2120 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2120 as code 2125 and data 2126.

In some embodiments, I/O interface 2130 may be configured to coordinate I/O traffic between processor 2110, system memory 2120, computing device 2170, and any peripheral devices in the computer system, including network interface 2140 or other peripheral interfaces such as various types of persistent and/or volatile storage devices. In some embodiments, I/O interface 2130 may perform any necessary protocol, timing or other data transformations to convert data signals from one component (e.g., system memory 2120) into a format suitable for use by another component (e.g., processor 2110). In some embodiments, I/O interface 2130 may include support for devices attached through various types of peripheral buses, such as a variant of the Peripheral Component Interconnect (PCI) bus standard or the Universal Serial Bus (USB) standard, for example. In some embodiments, the function of I/O interface 2130 may be split into two or more separate components, such as a north bridge and a south bridge, for example. Also, in some embodiments some or all of the functionality of I/O interface 2130, such as an interface to system memory 2120, may be incorporated directly into processor 2110.

Network interface 2140 may be configured to allow data to be exchanged between computing device 2100 and other devices 2160 attached to a network or networks 2150, such as other computer systems or devices. In various embodiments, network interface 2140 may support communication via any suitable wired or wireless general data networks, such as types of Ethernet network, for example. Additionally, network interface 2140 may support communication via telecommunications/telephony networks such as analog voice networks or digital fiber communications networks, via storage area networks such as Fibre Channel SANs, or via any other suitable type of network and/or protocol.

In some embodiments, system memory 2120 may represent one embodiment of a computer-accessible medium configured to store at least a subset of program instructions and data used for implementing the methods and apparatus discussed in the context of FIG. 1 through FIG. 16. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2100 via I/O interface 2130. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2100 as system memory 2120 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2140. Portions or all of multiple computing devices such as that illustrated in FIG. 21 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above are described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system, comprising:
one or more thermodynamic chips comprising a plurality of oscillators configured to perform a layer normalization, the plurality of oscillators comprising:
input oscillators;
output oscillators; and
intermediate oscillators,
wherein to perform the layer normalization, the plurality of oscillators are configured to:
obtain thermodynamic data on the input oscillators as initial values;
couple to each other to implement a set of engineered potentials, wherein the set of engineered potentials thermodynamically implements the layer normalization; and
perform one or more thermodynamic evolutions using the set of engineered potentials,
wherein the one or more thermodynamic evolutions performed using the set of engineered potentials cause:
a mean oscillator of the intermediate oscillators to:
evolve to obtain a mean value, encoded as thermodynamic data, of respective position degrees of freedom of the input oscillators; and
evolve to shift the initial value of each input oscillator by the mean value;
a variance oscillator of the intermediate oscillators to evolve to obtain a variance value, encoded as thermodynamic data, of the respective position degree of freedom of the input oscillators; and
the output oscillators to evolve to obtain result values of the layer normalization based on the thermodynamic data provided to the input oscillators, the mean value, and the variance value.

2. The system of claim 1, wherein the set of engineered potentials comprises a first potential, wherein thermodynamic evolution according to the first potential causes the mean oscillator of the intermediate oscillators to evolve to obtain the mean value, encoded as thermodynamic data, of the respective position degrees of freedom of the input oscillators, wherein the mean oscillator is coupled with respective ones of the input oscillators.

3. The system of claim 2, wherein the set of engineered potentials comprises a second potential, wherein thermodynamic evolution according to the second potential causes the mean oscillator of the intermediate oscillators to evolve to shift the initial value of each input oscillator by the mean value, wherein the mean oscillator is coupled with respective ones of the input oscillators.

4. The system of claim 3, wherein the set of engineered potentials comprises a third potential, wherein thermodynamic evolution according to the third potential causes the variance oscillator of the intermediate oscillators to evolve to obtain the variance value, encoded as thermodynamic data, of the respective position degree of freedom of the input oscillators, wherein the variance oscillator is coupled with respective ones of the input oscillators.

5. The system of claim 4, wherein the set of engineered potentials comprises a fourth potential, wherein thermodynamic evolution according to the fourth potential causes a variance reciprocal oscillator of the intermediate oscillators to evolve to obtain a reciprocal variance value, encoded as thermodynamic data, wherein:
the reciprocal variance value represents a reciprocal of a variance of the input values of the respective position degrees of freedom of the input oscillators; and
the variance reciprocal oscillator is coupled with the variance oscillator.

6. The system of claim 5, wherein the set of engineered potentials comprises a fifth potential, wherein thermodynamic evolution according to the fifth potential causes the output oscillators to evolve to obtain the result values of the layer normalization based on the thermodynamic data provided to the input oscillators, the mean value, and the variance reciprocal value, wherein the result values of the layer normalization obtained by the output oscillators comprise:
thermodynamic data stored on respective ones of the output oscillators that corresponds to the shifted input oscillators multiplied by the reciprocal variance value.

7. The system of claim 1, wherein the plurality of oscillators of the one or more thermodynamic chips further comprises a variance reciprocal oscillator, and wherein to perform the layer normalization, the plurality of oscillators are further configured to:
couple the variance reciprocal oscillator to the variance oscillator, wherein the variance oscillator has evolved to obtained the variance value; and
cause the variance reciprocal oscillator to evolve to obtain a reciprocal variance value, encoded as thermodynamic data, wherein the reciprocal variance value represents a reciprocal of a variance of the input values of the respective position degrees of freedom of the input oscillators.

8. The system of claim 7, wherein to implement respective ones of the set of engineered potentials the variance reciprocal oscillator is implemented using a given one of the oscillators of the one or more thermodynamic chips which has a cubic function energy potential.

9. The system of claim 7, wherein the mean oscillator, the variance oscillator, and the variance reciprocal oscillator are respectively configured to have an adjustable mass or an adjustable frequency.

10. The system of claim 7, wherein to obtain a result of the layer normalization, the oscillators are configured to implement a three-body coupling between respective ones of the output oscillators, respective ones of the input oscillators storing the mean shifted initial values, and the variance reciprocal oscillator.

11. The system of claim 1, wherein the input oscillators are configured to encode the thermodynamic data for the initial input values using a position degree of freedom of respective ones of the input oscillators.

12. A method comprising,
obtaining thermodynamic data, as input values, on input oscillators of a plurality of oscillators of one or more thermodynamic chips;
coupling the plurality of oscillators to each other to implement a set of engineered potentials, wherein the set of engineered potentials thermodynamically implements layer normalization; and
performing one or more thermodynamic evolutions using the set of engineered potentials,
wherein the thermodynamic evolution using on the set of engineered potentials causes output oscillators of the plurality of oscillators to obtain a result of the layer normalization based on the thermodynamic data provided to the input oscillators.

13. The method of claim 12, wherein performing the one or more thermodynamic evolutions using the set of engineered potentials comprises:
coupling a mean oscillator of the plurality of oscillators with the input oscillators; and
performing a first thermodynamic evolution using a first potential of the set of engineered potentials, wherein a mean oscillator of the intermediate oscillators evolve to obtain a mean value, encoded as thermodynamic data, of the respective position degrees of freedom of the input oscillators.

14. The method of claim 13, wherein performing the one or more thermodynamic evolutions using the set of engineered potentials comprises:
performing a second thermodynamic evolution using a second potential of the set of engineered potentials, wherein the initial value of each input oscillator evolve to shift by the mean value.

15. The method of claim 14, wherein performing the one or more thermodynamic evolutions using the set of engineered potentials comprises:
coupling a variance oscillator with the input oscillators; and
performing a third thermodynamic evolution using a third potential of the set of engineered potentials, wherein the variance oscillator evolves to obtain the variance value, encoded as thermodynamic data, of the respective position degree of freedom of the input oscillators.

16. The method of claim 15, wherein performing the one or more thermodynamic evolutions using the set of engineered potentials comprises:
coupling a variance reciprocal oscillator of the intermediate oscillators with the variance oscillator; and
performing a fourth thermodynamic evolution using a fourth potential of the set of engineered potentials, wherein:
the variance reciprocal oscillator evolves to obtain a reciprocal variance value, encoded as thermodynamic data; and
the reciprocal variance value represents a reciprocal of a variance of the input values of the respective position degrees of freedom of the input oscillators.

17. The method of claim 16, wherein performing one or more thermodynamic evolutions using the set of engineered potentials comprises:
coupling the variance reciprocal oscillator, input oscillators that have been shifted by the mean value, and the output oscillators with each other, and
performing a fifth thermodynamic evolution using a fifth potential of the set of engineered potentials, wherein the output oscillators evolve to obtain result values of the layer normalization based on the thermodynamic data provided to the input oscillators, the mean value, and the variance reciprocal value, wherein the result values of the layer normalization obtained by the output oscillators comprises:
thermodynamic data stored on respective ones of the output oscillators that corresponds to the shifted input oscillators multiplied by the reciprocal variance value.

18. The method of claim 12, wherein the obtained thermodynamic data on the input oscillators are obtained from a layer of a transformer neural network architecture, wherein the transformer neural network architecture implements a transformer neural network thermodynamically.

19. The method of claim 18, wherein the result of the layer normalization is provided to a next layer of the transformer neural network architecture.

20. One or more non-transitory, computer-readable, storage media storing program instructions that, when executed on or across one or more processors, cause the one or more processors to:
initiate one or more thermodynamic chips to implement layer normalization, wherein the one or more thermodynamic chips comprise oscillators;
cause the oscillators of the thermodynamic chips to thermodynamically evolve according to one or more engineered potentials, wherein the one or more engineered potentials thermodynamically implement the layer normalization; and
cause the oscillators to provide a result of the layer normalization.
